(19) United States
(12) Patent Application Publication
(10) Pub. No.: US 2026/0302290 A1
(43) Pub. Date: Oct. 1, 2026

(54) CONTROL METHOD FOR FUEL CELL SYSTEM AND CONTROL DEVICE FOR FUEL CELL SYSTEM

(71) Applicant: Nissan Motor Co., Ltd., Yokohama-shi, Kanagawa (JP)

(72) Inventor: Takanori OKU, Kanagawa (JP)

(21) Appl. No.: 19/480,413

(22) PCT Filed: May 19, 2023
(86) PCT No.: PCT/JP2023/018790

§ 371 Date: Oct. 31, 2025

(51) Int. Cl. H01M 8/0432; H01M 8/04014; H01M 8/04537; H01M 8/04992; H01M 8/0612; H01M 8/12; H01M 8/1231

(52) U.S. Cl. CPC H01M 8/04373; H01M 8/04022; H01M 8/04328; H01M 8/04634; H01M 8/04992; H01M 8/0618; H01M 8/1231; H01M 2008/1293

(57) ABSTRACT

A control method is provided for a fuel cell system including a solid oxide fuel cell stack that uses a hydrocarbon-based fuel as a fuel and that contains, at an anode, a reforming catalyst for reforming the fuel and an oxidation catalyst for oxidizing the fuel. The control method includes warming up the fuel cell system by a first warm-up phase and a second warm-up phase. In the first warm-up phase, heated air is circulated at least to a cathode to warm up the fuel cell system using heat of the heated air. In the second warm-up phase, after the first warm-up phase, a mixture of the fuel and air is introduced into the anode, the fuel is oxidized by the oxidation catalyst, and warm-up is performed using heat generated by an oxidation reaction of the fuel.

### CROSS-REFERENCE TO RELATED APPLICATIONS

This application is a U.S. national stage application of International Application No. PCT/JP2023/018790, filed on May 19, 2023.

### BACKGROUND

### Technical Field

The present invention relates to a control method and a control device for a fuel cell system including a solid oxide fuel cell stack using a hydrocarbon as a fuel.

### Background Art

JP2011-029049A discloses a method for activating a fuel cell system in which a hydrocarbon gas and oxygen are introduced into a cathode (air electrode) at the time of activating the fuel cell system, and the hydrocarbon gas and the oxygen are subjected to a complete oxidation reaction using a catalyst, thereby shortening a time until stable operation.

### SUMMARY

At the time of activating a fuel cell system that generates electricity using a solid oxide fuel cell stack, it is usually necessary to warm up to a temperature at which electricity generation is possible. Further, the warm-up of the fuel cell system (in particular, fuel cell stack) is generally performed by circulating heated air or the like to a cathode. However, since the warm-up method heats the fuel cell stack only from a cathode side, there are problems that energy efficiency is poor and it takes a long period of time for warm-up.

In addition, even when not only air but also a fuel is circulated to the cathode and heat generated by an oxidation reaction of the fuel at the cathode is used for warming up, the above problems occur as long as heating is unilaterally performed from the cathode side.

An object of the present invention is to provide a control method and a control device for a fuel cell system capable of warming up with higher energy efficiency and completing warm-up in a shorter period of time than in the case of unilateral heating from a cathode side.

An aspect of the present invention relates to a control method for a fuel cell system including a solid oxide fuel cell stack that uses a hydrocarbon as a fuel and that contains, at an anode, a reforming catalyst for reforming a fuel and an oxidation catalyst for oxidizing the fuel. The control method for a fuel cell system including: warming up the fuel cell system by a first warm-up phase in which heated air is circulated at least to a cathode to warm up the fuel cell system using heat of the heated air, and a second warm-up phase in which, after the first warm-up phase, a mixture of the fuel and air is introduced into the anode, the fuel is oxidized by the oxidation catalyst, and warm-up is performed using heat generated by an oxidation reaction of the fuel.

### BRIEF DESCRIPTION OF DRAWINGS

Referring now to the attached drawings which form a part of this original disclosure, illustrative embodiments are shown.

FIG. 1 is a diagram illustrating a schematic configuration of a fuel cell system.

FIG. 2 is a diagram illustrating a configuration of a fuel cell.

FIG. 3 is a graph illustrating energy efficiency and the like in a first stack when warm-up is performed by a method in the related art.

FIG. 4 is a graph illustrating energy efficiency and the like in a second stack when warm-up is performed by the method in the related art.

FIG. 5 is a diagram illustrating heat transfer characteristics of the fuel cell.

FIG. 6 is a graph illustrating oxidation characteristics of nickel.

FIG. 7 is a graph illustrating reduction characteristics of nickel.

FIG. 8 is a graph illustrating the reduction characteristics of nickel when an anode electrode contains an oxidation catalyst.

FIG. 9 is a diagram schematically illustrating a relation between a temperature at which oxidation of the fuel starts and a temperature at which oxidation of the reforming catalyst starts.

FIG. 10 is a graph illustrating a change in an oxidation state of nickel in the fuel cell stack 10.

FIG. 11 is a flowchart of warm-up control according to the present embodiment.

FIG. 12 is a diagram illustrating a state of the fuel cell system in step S11 of a first warm-up phase.

FIG. 13 is a diagram illustrating the state of the fuel cell system in step S12 of the first warm-up phase.

FIG. 14 is a diagram illustrating the state of the fuel cell system in a second warm-up phase.

FIG. 15 is a diagram illustrating the state of the fuel cell system in an electricity generation phase.

FIG. 16 is a graph schematically illustrating a temperature distribution of the fuel cell stack in the first warm-up phase.

FIG. 17 is a graph illustrating a schematic distribution of an anode temperature and a cell resistance in the first warm-up phase.

FIG. 18 is a graph schematically illustrating a relation between the anode temperature and the cell resistance in the first warm-up phase.

FIG. 19 is a graph schematically illustrating a temperature distribution occurring in the first warm-up phase when the fuel cell stack has a parallel flow structure.

FIG. 20 is a diagram illustrating an effect of step S14 in the second warm-up phase.

FIG. 21 is a diagram illustrating an effect of step S15 in the second warm-up phase.

### DETAILED DESCRIPTION OF EMBODIMENTS

Hereinafter, embodiments of the present invention will be described with reference to the drawings.

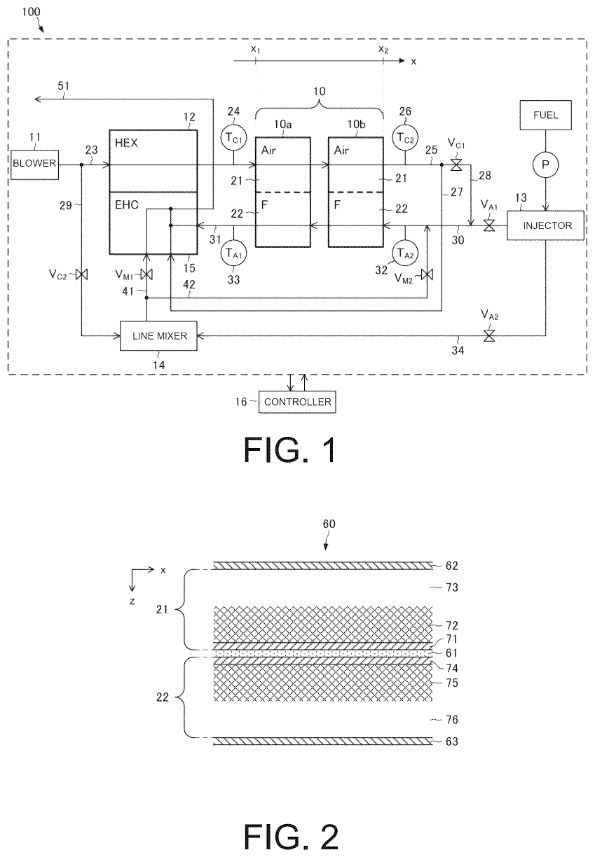

FIG. 1 is a diagram illustrating a schematic configuration of a fuel cell system 100. The fuel cell system 100 is a system that generates electricity by causing a fuel and an oxidant to circulate to a fuel cell stack 10. The fuel cell system 100 may be installed as a stationary electricity generation facility or may be mounted on a vehicle or other moving bodies.

The fuel to be used by the fuel cell system 100 is, for example, methane or other hydrocarbon-based fuels, and the fuel cell system 100 reforms the fuel in the fuel cell stack 10 when generating electricity. That is, the fuel cell system 100 performs so-called internal reforming during electricity generation. The hydrocarbon-based fuel is alkane, alkene, alkyne, aromatic hydrocarbon, or alcohol, aldehyde, ketone, ether, or the like containing a functional group containing an element (for example, oxygen) other than hydrocarbon. In the present embodiment, the fuel is methane. A component to be used as the oxidant by the fuel cell system 100 is oxygen or the like. In the present embodiment, the oxidant is air.

The fuel cell system 100 can generate electricity when the fuel cell stack 10 reaches, for example, about 400° C. to 500° C. or higher. Therefore, at the time of activating the fuel cell system 100, it is necessary to warm up the fuel cell system 100 (particularly, fuel cell stack 10) until electricity generation is possible. Hereinafter, the control on each unit of the fuel cell system 100 for continuously generating electricity is referred to as electricity generation control, and the control on each unit of the fuel cell system 100 for warming up such that electricity generation is possible at the time of activation is referred to as warm-up control. The temperature at which the fuel cell stack 10 may generate electricity is referred to as a target temperature T_{target} of the warm-up control. The target temperature T_{target} is a temperature at which a reforming reaction such as a partial oxidation reforming reaction may occur.

As illustrated in FIG. 1, the fuel cell system 100 includes the fuel cell stack 10, a blower 11, a heat exchanger 12, an injector 13, a line mixer 14, a combustor 15, a controller 16, and the like.

The fuel cell stack 10 is a solid oxide fuel cell stack implemented by stacking a plurality of solid oxide fuel cells (hereinafter simply referred to as fuel cells 60). A configuration of the fuel cell 60 will be described in detail later. The fuel cell stack 10 may be implemented by coupling a plurality of stacks. In the present embodiment, the fuel cell stack 10 includes two fuel cell stacks including a first stack 10a and a second stack 10b.

The first stack 10a is a fuel cell stack into which the reformed fuel (hydrogen) is to be introduced during electricity generation. The second stack 10b is a fuel cell stack into which the unreformed fuel is to be introduced during electricity generation. Therefore, along the flow of the fuel, the first stack 10a is disposed on a downstream side, and the second stack 10b is disposed on an upstream side. In other words, along the flow of the air circulating as the oxidant, the first stack 10a is disposed on the upstream side, and the second stack 10b is disposed on the downstream side.

The first stack 10a and the second stack 10b may have different configurations in terms of a structure, a size, presence or absence or a distribution of a catalyst, and the like. However, in the present embodiment, for simplicity, it is assumed that the first stack 10a and the second stack 10b have substantially the same configuration. Therefore, hereinafter, the fuel cell system 100 is treated as including the fuel cell stack 10 in which the first stack 10a and the second stack 10b are integrated as a whole without distinguishing the first stack 10a and the second stack 10b unless otherwise particularly required.

For example, cathodes (air electrodes) of the first stack 10a and second stack 10b which are coupled to each other are collectively referred to as a cathode 21 of the fuel cell stack 10. Similarly, anodes (fuel electrodes) of the first stack 10a and the second stack 10b which are coupled to each other are collectively referred to as an anode 22 of the fuel cell stack 10. In FIG. 1, a portion indicated by “Air” is the cathode 21, and a portion indicated by “F” is the anode 22.

In addition, a direction along the flow of the air circulated to the cathode 21 is defined as an x-direction, an inlet of the cathode 21 is defined as a position x₁, and an outlet of the cathode 21 is defined as a position x₂. In the present embodiment, the fuel cell stack 10 has a structure in which the fuel or the like of the anode 22 is circulated to face the air of the cathode 21 (so-called counterflow structure). Therefore, an inlet of the anode 22 is at the position x₂, and an outlet of the anode 22 is at the position x₁. However, the fuel cell stack 10 may have a structure in which the fuel or the like of the anode 22 is circulated parallel to the air of the cathode 21 (so-called parallel flow structure). In this case, the inlet of the anode 22 is at the position x₁, and the outlet of the anode 22 is at the position x₂.

In addition, although not illustrated, the fuel cell stack 10 includes, for example, a cell resistance detector that detects an electrical resistance between the cathode 21 and the anode 22, that is, an internal resistance (so-called cell resistance) of the fuel cell stack 10 for each of one or a plurality of fuel cells 60. Therefore, the cell resistance of the fuel cell stack 10 may be appropriately acquired. In the present embodiment, a distribution of the cell resistance along the x-direction is referred to as a cell resistance Rₓ.

The blower 11 causes air, which is an oxidant, to circulate to the cathode 21 via a first air supply path 23. The first air supply path 23 is provided with the heat exchanger 12 (HEX). The heat exchanger 12 heats the air circulated to the cathode 21 by heat generated in the combustor 15. Therefore, the blower 11 causes the air heated in the heat exchanger 12 (hereinafter referred to as heated air) to circulate to the cathode 21. A temperature T_{C1} of the heated air is detected by a temperature sensor 24 provided at the inlet of the cathode 21. The temperature sensor 24 detects the temperature T_{C1} of the heated air inside the fuel cell stack 10. Therefore, when there is a temperature change in the fuel cell stack 10, the temperature T_{C1} is a value reflecting the temperature change.

The air circulating through the cathode 21 is used for, for example, an electricity generation reaction and then discharged from the fuel cell stack 10 via a cathode discharge path 25. A temperature T_{C2} of the gas discharged from the cathode 21 (hereinafter referred to as cathode off gas) is detected by a temperature sensor 26 provided at the outlet of the cathode 21. The temperature sensor 26 detects the temperature T_{C2} of the heated air inside the fuel cell stack 10. Therefore, when there is a temperature change in the fuel cell stack 10, the temperature T_{C2} is a value reflecting the temperature change.

In principle, the cathode discharge path 25 guides the cathode off gas to the combustor 15. In the present embodiment, the cathode discharge path 25 branches into a first path 27 for introducing the cathode off gas into the combustor 15 and a second path 28 for introducing the cathode off gas into a first fuel supply path 30. Whether to introduce the cathode off gas into the first fuel supply path 30 via the second path 28 and an amount of the cathode off gas circulated to the first fuel supply path 30 are adjusted by a valve V_{C1}.

The blower 11 can supply air to the line mixer 14 via the second air supply path 29. The second air supply path 29 is branched from the first air supply path 23, for example. A supply amount of the air to the line mixer 14 is adjusted by a valve V_{C2}.

The injector 13 supplies, to the anode 22 via the first fuel supply path 30, the fuel to be supplied from a pump P. A supply timing and a supply amount of the fuel to the anode 22 are adjusted by a valve VAL. The fuel circulating through the anode 22 is used for, for example, an electricity generation reaction and then discharged from the fuel cell stack 10 via the anode discharge path 31. The anode discharge path 31 guides a gas discharged from the anode 22 (hereinafter referred to as anode off gas) to the combustor 15.

A temperature T_{A2} of the fuel and other gases circulated to the anode 22 is detected by a temperature sensor 32. A temperature T_{A1} of the anode off gas is detected by a temperature sensor 33. The temperature sensors 32 and 33 detect the temperatures T_{A2} and T_{A1} inside the fuel cell stack 10, respectively. Therefore, when there is a temperature change in the fuel cell stack 10, the temperatures T_{A2} and T_{A1} are values reflecting the temperature change. In addition, the anode discharge path 31 is provided with an oxygen concentration sensor (not illustrated). Therefore, a concentration of oxygen contained in the anode off gas may be appropriately acquired.

The injector 13 can supply, to the line mixer 14 via the second fuel supply path 34, the fuel to be supplied from the pump P. A supply timing and a supply amount of the fuel to the line mixer 14 are adjusted by a valve V_{A2}.

The line mixer 14 generates a mixture of the air to be supplied from the second air supply path 29 and the fuel to be supplied from the second fuel supply path 34. The line mixer 14 can supply the mixture to the combustor 15 via a first mixture supply path 41 connected to the combustor 15. In addition, the line mixer 14 can supply the mixture to the anode 22 via a second mixture supply path 42 connected to the first fuel supply path 30. A supply destination of the mixture is controlled by a valve V_{M1} provided in the first mixture supply path 41 and a valve V_{M2} provided in the second mixture supply path 42. For example, the mixture is supplied to the combustor 15 by opening the valve V_{M1} and closing the valve V_{M2}. In addition, the mixture is supplied to the anode 22 by opening the valve V_{M1} and closing the valve V_{M2}.

The combustor 15 combusts the mixture of the air and the fuel to be supplied from the line mixer 14, a mixture of the cathode off gas and the anode off gas, or both of the two mixtures. As described above, heat generated by the combustion reaction of the combustor 15 is used to heat the air circulated to the cathode 21 in the heat exchanger 12. A discharged gas of the combustor 15 is discharged to outside of the fuel cell system 100 via a discharge path 51. The combustor 15 is implemented by, for example, a catalyst combustor using an electrically heated catalyst (EHC). A temperature of the combustor 15 (hereinafter referred to as combustor temperature T_{b}) may be appropriately acquired by a temperature sensor (not illustrated).

The controller 16 is a control device for the fuel cell system 100 and includes one or a plurality of computers. The controller 16 is programmed to perform the electricity generation control or the warm-up control as necessary by comprehensively controlling the units constituting the fuel cell system 100 as described above.

FIG. 2 is a diagram illustrating a configuration of the fuel cell 60. As illustrated in FIG. 2, the fuel cell 60 has a structure in which the cathode 21 and the anode 22 are stacked via a solid electrolyte 61. The fuel cells 60 are stacked via separators 62 and 63.

The solid electrolyte 61 is made of an ion-conductive solid oxide ceramic that transmits an oxide ion. The solid electrolyte 61 is made of, for example, stabilized zirconia doped with a rare earth oxide, a ceria-based solid solution, or a perovskite-type oxide. More specifically, the solid electrolyte 61 is yttria-stabilized zirconia (YSZ), scandium-stabilized zirconia (SSZ), samarium-doped ceria (SDC), gadolinium-doped ceria (GDC), lanthanum strontium magnesium gallate (LSGM), or the like.

The cathode 21 includes, for example, a cathode electrode 71, a metal support 72, and a cathode gas flow path 73.

The cathode electrode 71 functions as an electrode and also has a catalyst function of converting oxygen molecules into oxide ions. The cathode electrode 71 is made of, for example, an oxide of an alloy of lanthanum, strontium, manganese, or cobalt.

The metal support 72 is a porous body made of a metal, and supports the cathode electrode 71 while allowing air, which is an oxidant, to pass through the cathode electrode 71. The metal support 72 is made of, for example, iron, chromium, nickel, titanium, or an alloy thereof (in particular, stainless steel).

The cathode gas flow path 73 is formed between the metal support 72 and the separator 62. The cathode gas flow path 73 allows the oxidant (air) to circulate to the cathode 21.

The anode 22 includes, for example, an anode electrode 74, a metal support 75, and an anode gas flow path 76.

The anode electrode 74 functions as an electrode and also functions as a catalyst that promotes a chemical reaction for reforming or electricity generation (hereinafter, simply referred to as reforming catalyst). The anode electrode 74 is made of, for example, a metal functioning as a reforming catalyst or a cermet of a metal functioning as a reforming catalyst and the above-described solid oxide ceramic. The reforming catalyst contained in the anode electrode 74 is, for example, fine particles composed of a transition metal such as iron, nickel, cobalt, copper, molybdenum, or lanthanum, a noble metal such as ruthenium, platinum, rhodium, iridium, silver, or palladium, or a mixture thereof.

In addition, the anode electrode 74 functions as a catalyst that promotes an oxidation reaction of the fuel when the fuel (methane) and oxygen (air) circulate through the anode 22 (hereinafter, referred to as oxidation catalyst). That is, the anode electrode 74 contains an oxidation catalyst in addition to the reforming catalyst. The oxidation catalyst contained in the anode electrode 74 is made of, for example, a metal or a cermet exemplified as the reforming catalyst, and functions as an oxidation catalyst in relation to a specific fuel, the reforming catalyst, and the like.

In the present embodiment, the reforming catalyst contained in the anode electrode 74 contains a reforming catalyst containing nickel as a catalyst active material and barium zirconate (BYZ) as a carrier. Therefore, as the oxidation catalyst, for example, an oxidation catalyst in which platinum or palladium is used as the catalyst active material and cerium oxide or ceria-zirconia (CZ) is used as the carrier can be used. In the present embodiment, the anode electrode 74 contains an oxidation catalyst containing platinum as the catalyst active material. Hereinafter, for simplicity, nickel contained in the anode electrode 74 is referred to as the reforming catalyst, and platinum contained in the anode electrode 74 is referred to as the oxidation catalyst.

The metal support 75 is a porous body formed of a metal, and supports the anode electrode 74 while passing the fuel, air, or the like through the anode electrode 74. The metal support 75 is made of, for example, the same material as the metal support 72 of the cathode 21.

The anode gas flow path 76 is formed between the metal support 75 and the separator 63. The anode gas flow path 76 allows the fuel, or the fuel and air to circulate to the anode 22.

Hereinafter, the warm-up control of the fuel cell system 100 implemented as described above will be described.

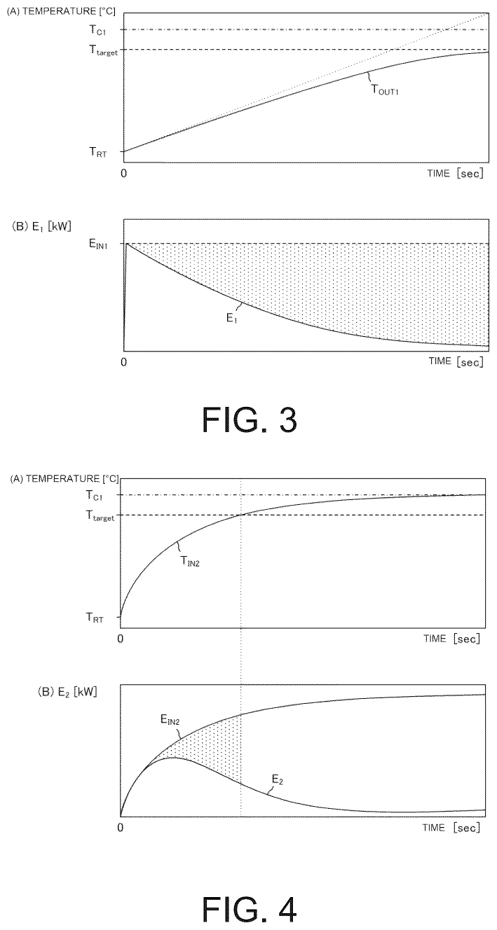

FIG. 3 is a graph illustrating energy efficiency and the like in the first stack 10a when warm-up is performed by a method in the related art. The “method in the related art” is warm-up control in which the heated air is circulated to the cathode 21 and the anode 22 is unilaterally heated from the cathode 21 side. (A) of FIG. 3 illustrates a transition of a temperature T_{OUT1} of the gas (heated air) discharged from the first stack 10a in the warm-up control in the related art. (B) of FIG. 3 is a graph illustrating a transition of an energy E₁ contributing to a temperature rise of the first stack 10a in the warm-up control in the related art.

As illustrated in (A) of FIG. 3, in the warm-up control, the temperature T_{C1} of the heated air introduced into the cathode 21 is set to be, for example, higher than the target temperature T_{target} and substantially constant. When the warm-up control is started, the heat of the heated air circulating through the cathode 21 is taken by the first stack 10a. Accordingly, the temperature of the first stack 10a gradually increases.

In an initial stage of the warm-up control, the temperature T_{OUT1} of the gas discharged from the first stack 10a decreases to about a room temperature T_{RT}. However, when the temperature of the first stack 10a rises with the elapse of time, the temperature T_{OUT1} of the gas discharged from the first stack 10a also rises. Finally, when the temperature of the first stack 10a is about the target temperature T_{target}, the temperature T_{OUT1} of the gas discharged from the first stack 10a also is about the target temperature T_{target}.

At this time, ideally, it is desirable that the temperature T_{OUT1} of the gas discharged from the first stack 10a increases in proportion to the elapse of time (or in accelerated manner) as indicated by the dotted line. However, actually, the increase in the temperature T_{OUT1} of the gas discharged from the first stack 10a is saturated with the elapse of time, and the temperature T_{OUT1} of the gas discharged from the first stack 10a gradually approaches the target temperature T_{target} over a long period of time.

Therefore, as illustrated in (B) of FIG. 3, in the warm-up control in the related art, the energy E₁ contributing to the temperature rise of the first stack 10a gradually decreases with the elapse of time with respect to an energy E_{IN1} (input energy) of the heated air when circulating through the first stack 10a. That is, as indicated by hatching, an energy loss with respect to the energy E_{IN1} increases with the elapse of time. Therefore, in the warm-up control in the related art, the energy efficiency of warm-up deteriorates with the elapse of time.

FIG. 4 is a graph illustrating energy efficiency and the like in the second stack 10b when warm-up is performed by the method in the related art. (A) of FIG. 4 is a graph illustrating a transition of a temperature T_{IN2} of the heated air introduced from the first stack 10a into the second stack 10b in the warm-up control in the related art. (B) of FIG. 4 is a graph illustrating a transition of an energy E₂ contributing to a temperature rise of the second stack 10b in the warm-up control in the related art.

As illustrated in (A) of FIG. 4, since the heated air passing through the first stack 10a is introduced into the second stack 10b, the temperature T_{IN2} of the heated air introduced into the second stack 10b is lower than the target temperature T_{target} and is initially about the room temperature T_{RT}. Thereafter, as the temperature of the first stack 10a rises, the temperature T_{IN2} of the heated air introduced into the second stack 10b rises with the elapse of time. However, a rise rate of the temperature T_{IN2} of the heated air introduced into the second stack 10b is saturated with the elapse of time. Therefore, finally, although the temperature T_{IN2} of the heated air introduced into the second stack 10b finally approaches the temperature T_{C1} of the heated air at the inlet of the cathode 21, it takes more time for the second stack 10b to reach the target temperature T_{target} than the first stack 10a.

Therefore, in the warm-up control in the related art, the energy E_{IN2} of the heated air when circulating through the second stack 10b and the energy E₂ contributing to the temperature rise of the second stack 10b change as illustrated in (B) of FIG. 4. That is, as indicated by hatching, the energy loss with respect to the energy E_{IN2} increases with the elapse of time only while the temperature T_{IN2} of the heated air introduced into the second stack 10b reaches the target temperature T_{target}. Further, even after the temperature T_{IN2} of the heated air introduced into the second stack 10b reaches the target temperature T_{target}, the energy loss with respect to the energy E_{IN2} increases with the elapse of time. Therefore, in the warm-up control in the related art, the energy efficiency of warm-up also deteriorates in the second stack 10b with the elapse of time.

Therefore, even in the fuel cell stack 10 as a whole, in the method of unilaterally heating the anode 22 from the cathode 21 side as in the warm-up control in the related art, the energy efficiency of warm-up is poor, and a long period of time is required for warm-up.

Therefore, in the warm-up control according to the present embodiment, a method of directly heating the cathode electrode 71 and the anode electrode 74 by causing the anode electrode 74 to generate heat is combined with a method of circulating the heated air to the cathode 21 and heating the anode 22 from the cathode 21 side, thereby completing the warm-up in a shorter period of time with higher energy efficiency than in the related art.

Specifically, in the warm-up control according to the present embodiment, the fuel cell system 100 is warmed up by two-stage warm-up including a first warm-up phase and a second warm-up phase.

The first warm-up phase is a first-stage warm-up performed when warm-up is started. In the first warm-up phase, heated air is circulated at least to the cathode 21 to warm up the fuel cell stack 10 using heat of the heated air.

The second warm-up phase is a second-stage warm-up performed after the first warm-up phase. In the second warm-up phase, a mixture of a fuel and air is introduced into the anode 22, and the fuel is oxidized at the anode electrode 74 by an oxidation catalyst. Then, the fuel cell stack 10 is warmed up by causing the anode electrode 74 to directly generate heat by the oxidation reaction of the fuel.

The warm-up in the second warm-up phase is performed in a temperature range lower than a temperature range in which a reforming reaction such as a partial oxidation reforming reaction may occur (for example, temperature range equal to or higher than target temperature T_{target}). In addition, the oxidation reaction of the fuel occurring in the second warm-up phase is, in principle, for completely oxidizing the fuel, and the mixture is mixed with sufficient air (oxygen) to such an extent as to be sufficient for a complete oxidation reaction of the fuel.

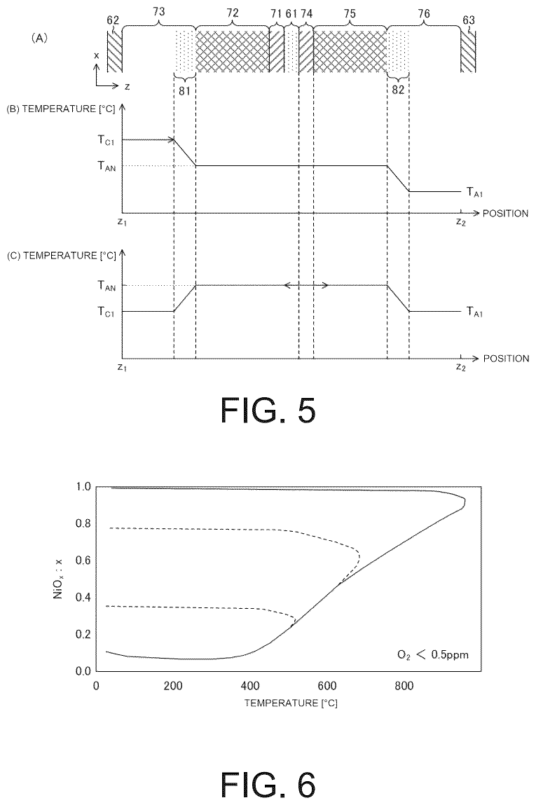

FIG. 5 is a diagram illustrating heat transfer characteristics of the fuel cell 60. (A) of FIG. 5 is a schematic diagram illustrating an xz cross section of the fuel cell 60. A z-direction is a direction perpendicular to an x-direction. Hereinafter, along the z-direction, an end portion of the cathode gas flow path 73 on a separator 62 side is defined as a position z₁, and an end portion of the anode gas flow path 76 on a separator 63 side is defined as a position z₂. (B) of FIG. 5 schematically illustrates a temperature distribution occurring when the heated air is circulated to the cathode gas flow path 73. (C) of FIG. 5 schematically illustrates a temperature distribution occurring when the anode electrode 74 is caused to generate heat by the oxidation reaction of the fuel.

As illustrated in (A) of FIG. 5, when the heated air is circulated to the cathode gas flow path 73, a boundary film 81 maintaining a laminar flow state is generated near an interface between the cathode gas flow path 73 and the metal support 72. The boundary film 81 has a large resistance to heat transfer from the heated air to the metal support 72 even when it is very thin. That is, the boundary film 81 substantially functions as a heat insulating material.

Therefore, as illustrated in (B) of FIG. 5, even when the heated air at the temperature T_{C1} is circulated to the cathode gas flow path 73, the temperature of the metal support 72 does not immediately reach the temperature T_{C1} of the heated air and remains at a temperature lower than the temperature T_{C1} of the heated air. However, as described above, the metal support 72, the cathode electrode 71, the solid electrolyte 61, the anode electrode 74, and the metal support 75 all contain a material having high thermal conductivity such as a metal. Therefore, the heat flowing into the metal support 72 is immediately transferred to the cathode electrode 71, the solid electrolyte 61, the anode electrode 74, and the metal support 75. Therefore, the metal support 72, the cathode electrode 71, the solid electrolyte 61, the anode electrode 74, and the metal support 75 have substantially the same temperature. Hereinafter, the temperature from the metal support 72 on a cathode 21 side to the metal support 75 on an anode 22 side is assumed to be substantially the same temperature, and is represented by a temperature of the anode electrode 74 (hereinafter, referred to as anode temperature T_{AN}).

In addition, as illustrated in (A) of FIG. 5, when the fuel or other gases is circulated to the anode gas flow path 76, a boundary film 82 is also generated near an interface between the anode gas flow path 76 and the metal support 75. The boundary film 82 substantially functions as a heat insulating material in heat transfer between the anode electrode 74 and the like and the gas circulating to the anode gas flow path 76. Therefore, as illustrated in (B) of FIG. 5, when the heated air at the temperature T_{C1} is circulated to the cathode gas flow path 73, the temperature of the gas circulating to the anode gas flow path 76 is lower than the anode temperature T_{AN}.

On the other hand, as illustrated in (C) of FIG. 5, when the anode electrode 74 is caused to directly generate heat by the oxidation reaction of the fuel, the anode temperature T_{AN} is immediately transmitted to the solid electrolyte 61, the cathode electrode 71, and the metal support 72 on the cathode 21 side. Similarly, the anode temperature T_{AN} is transmitted to the metal support 75 on the anode 22 side. However, as described above, since the boundary films 81 and 82 occur in the cathode gas flow path 73 and the anode gas flow path 76, respectively, the anode temperature T_{AN} is hardly transmitted to the gas such as the heated air circulating through the cathode gas flow path 73 and the anode gas flow path 76. However, since the chemical reaction for electricity generation occurs at the cathode electrode 71, the solid electrolyte 61, and the anode electrode 74, the fuel cell stack 10 (fuel cell system 100) can generate electricity as long as these temperatures reach a temperature at which the chemical reaction for electricity generation may occur (target temperature T_{target}).

Further, comparing a case where the fuel cell stack 10 is warmed up by circulating the heated air to the cathode gas flow path 73 as illustrated in (B) of FIG. 5 with a case where the fuel cell stack 10 is warmed up more directly by causing the anode electrode 74 to generate heat by the oxidation reaction of the fuel as illustrated in (C) of FIG. 5, since almost all of the generated thermal energy contributes to the temperature rise of the anode electrode 74, the energy efficiency is better when the anode electrode 74 is caused to generate heat by the oxidation reaction of the fuel as illustrated in (C) of FIG. 5.

However, the anode electrode 74 contains a reforming catalyst that is extremely easily oxidized (nickel in present embodiment). Therefore, when the mixture of the fuel and the air is circulated to the anode gas flow path 76 in order to cause an oxidation reaction of the fuel at the anode electrode 74, oxidation of the reforming catalyst usually proceeds. Further, when the oxidation proceeds, the reforming catalyst is difficult to function as a reforming catalyst, and may not substantially function as a reforming catalyst depending on a degree of oxidation.

FIG. 6 is a graph illustrating oxidation characteristics of nickel. In FIG. 6, the temperature and the degree of oxidation of nickel in an inert gas (here, nitrogen) atmosphere having an oxygen concentration of less than 0.5 ppm are indicated by an x value of NiOₓ (NiOₓ: x). As illustrated in FIG. 6, nickel contained in the anode electrode 74 as a reforming catalyst is extremely easily oxidized, and is deeply oxidized due to a temperature rise even when oxygen is contained in an extremely small amount.

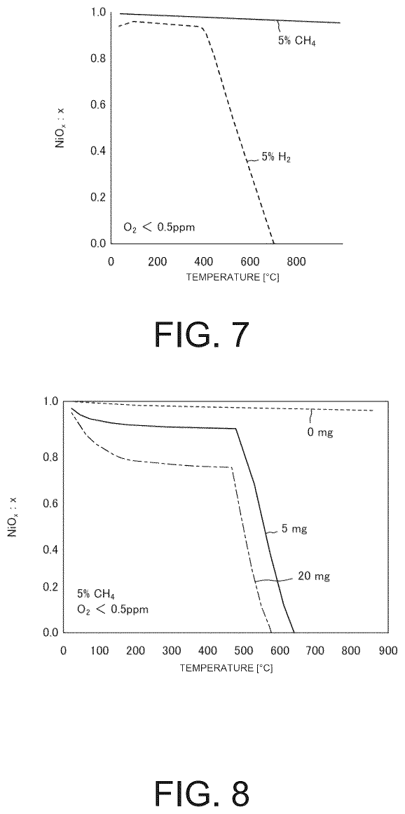

FIG. 7 is a graph illustrating reduction characteristics of nickel. FIG. 7 illustrates reduction characteristics of nickel in a case where a 5% fuel is added to the inert gas (nitrogen) having the oxygen concentration of less than 0.5 ppm. A solid line indicates the reduction characteristics of nickel when methane (CH₄) is contained as the fuel. A broken line indicates the reduction characteristics of nickel when hydrogen (H₂) is contained as the fuel.

As illustrated by the broken line in FIG. 7, even in a case where nickel is deeply oxidized (x≈1.0), when hydrogen is used as the fuel, nickel, which is a reforming catalyst, is reduced by a reduction power of hydrogen if the temperature rises, and may function as a reforming catalyst.

On the other hand, as illustrated by the solid line in FIG. 7, in a case where a hydrocarbon such as methane is used as the fuel, when nickel is deeply oxidized, nickel is hardly reduced even if the temperature rises. Therefore, in a case where an unreformed hydrocarbon-based fuel such as methane is used, when nickel, which is expected to function as a reforming catalyst, is deeply oxidized at the time of warm-up, the subsequent electricity generation is normally hindered. Therefore, when air (oxygen) is introduced into the anode gas flow path 76 in the warm-up control or the like, it is necessary to devise so as to function as a reforming catalyst during electricity generation, so as not to oxidize nickel contained in the anode electrode 74, or so as to reduce oxidized nickel.

FIG. 8 is a graph illustrating reduction characteristics of nickel when the anode electrode 74 contains an oxidation catalyst. In FIG. 8, as an example, the reduction characteristics of nickel when a content of the oxidation catalyst is different are indicated by a broken line, a solid line, and a one-dot chain line. The broken line indicates the reduction characteristics of nickel when the fuel cell stack 10 contains about 0 mg of the oxidation catalyst at the anode electrode 74 (substantially free of oxidation catalyst). The solid line indicates the reduction characteristics of nickel when the fuel cell stack 10 contains about 5 mg of the oxidation catalyst at the anode electrode 74. The one-dot chain line indicates the reduction characteristics of nickel when the fuel cell stack 10 contains about 20 mg of the oxidation catalyst at the anode electrode 74. FIG. 8 illustrates the reduction characteristics of nickel in an inert gas (nitrogen) having an oxygen concentration of less than 0.5 ppm and containing 5% methane.

As indicated by the broken line in FIG. 8, in a case where the anode electrode 74 is substantially free of the oxidation catalyst, even when methane, which is the unreformed fuel, is introduced, the reduction of the deeply oxidized nickel hardly proceeds due to the temperature rise. This is the same as the result indicated by the solid line in FIG. 7. On the other hand, as indicated by the solid line and the one-dot chain line in FIG. 8, when the anode electrode 74 contains the oxidation catalyst, even the deeply oxidized nickel is reduced due to the temperature rise. In particular, when a certain temperature is reached, reduction of nickel rapidly proceeds. In addition, as illustrated by bending of the graph, the temperature at which the reduction of nickel rapidly proceeds tends to shift to a low temperature side as the content of the oxidation catalyst at the anode electrode 74 increases.

Hereinafter, the temperature at which the reduction of even the deeply oxidized nickel rapidly proceeds is referred to as a nickel reduction temperature T_{RED}. When the anode electrode 74 contains an oxidation catalyst, the nickel reduction temperature T_{RED} is, for example, about 350° C. to about 500° C. In the fuel cell stack 10 according to the present embodiment, the nickel reduction temperature T_{RED} is about 400° C.

In the present embodiment, the anode electrode 74 contains an oxidation catalyst in addition to nickel, which is a reforming catalyst. Therefore, in the second warm-up phase, even when nickel, which is a reforming catalyst, is slightly oxidized by introducing the mixture of the fuel and the air into the anode gas flow path 76, the nickel is reduced and may function as a reforming catalyst when the fuel cell stack 10 reaches the target temperature T_{target}.

In a case where methane, which is an unreformed fuel, is introduced into shallowly oxidized nickel (for example, NiOₓ: x≈0.0 to 0.2) and the temperature is high, reduction of nickel may proceed even when the anode electrode 74 is free of an oxidation catalyst. However, a high temperature of about 700° C. or higher, that is, a temperature higher than the target temperature T_{target} is required.

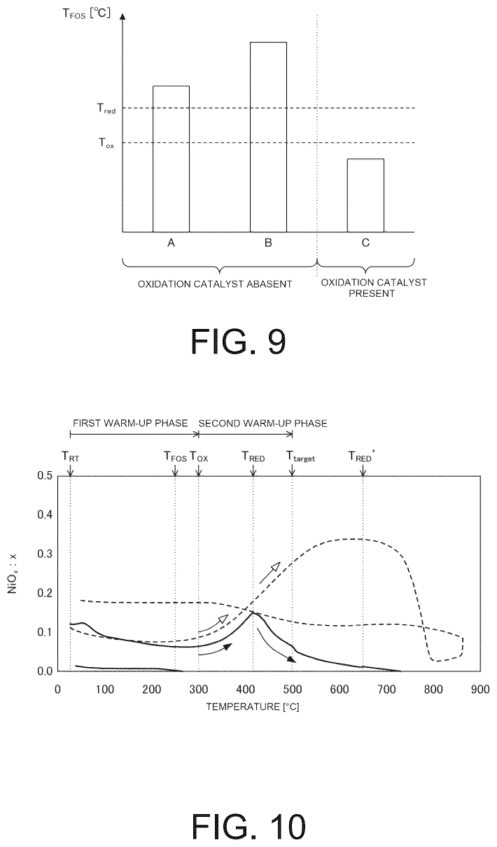

FIG. 9 is a diagram schematically illustrating a temperature at which oxidation of the fuel starts (hereinafter referred to as fuel oxidation temperature T_{FOS}) and a temperature at which oxidation of nickel starts (hereinafter referred to as nickel oxidation temperature T_{OX}). In FIG. 9, the fuel is methane. “A” indicates the fuel oxidation temperature T_{FOS} when the anode electrode 74 is free of the oxidation catalyst and the oxidation of nickel, which is a reforming catalyst, is relatively shallow (NiOₓ: x≈0.0 to 0.2). “B” indicates the fuel oxidation temperature T_{FOS} when the anode electrode 74 is free of the oxidation catalyst and the oxidation of nickel, which is a reforming catalyst, is deep (NiOₓ: x≈1.0). “C” indicates the fuel oxidation temperature T_{FOS} when the anode electrode 74 contains an oxidation catalyst.

As illustrated in FIG. 9, when the anode electrode 74 is free of the oxidation catalyst, the fuel oxidation temperature T_{FOS} changes depending on the depth of oxidation of nickel, which is a reforming catalyst. Specifically, as illustrated in the graphs “A” and “B”, the fuel oxidation temperature T_{FOS} tends to increase as the oxidation of nickel is deeper. However, in any case, the fuel oxidation temperature T_{FOS} is higher than the nickel oxidation temperature T_{OX} and further higher than the nickel reduction temperature T_{R}ED. On the other hand, as illustrated in the graph “C”, when the anode electrode 74 contains the oxidation catalyst, the fuel oxidation temperature T_{FOS} is lower than the nickel reduction temperature T_{RED}, and particularly, is lower than the nickel oxidation temperature T_{OX} due to the action of the oxidation catalyst. Therefore, in the warm-up control according to the present embodiment, the oxidation of the fuel starts at a temperature lower than the oxidation reaction of nickel.

The nickel oxidation temperature T_{OX} is about 300° C. to about 350° C. The fuel oxidation temperature T_{FOS} when the anode electrode 74 contains the oxidation catalyst is about 250° C. to about 300° C. In the fuel cell 60 according to the present embodiment, when methane is used as the fuel, the nickel oxidation temperature T_{OX} is about 300° C., and the fuel oxidation temperature T_{FOS} is about 250° C. The fuel oxidation temperature T_{FOS} varies depending on the specific fuel.

FIG. 10 is a graph illustrating a change in the oxidation state of nickel in the fuel cell stack. A solid line in FIG. 10 indicates a change in the oxidation state of nickel in the fuel cell stack 10 according to the present embodiment in which the anode electrode 74 contains an oxidation catalyst. A broken line in FIG. 10 indicates a change in the oxidation state of nickel in a fuel cell stack according to a comparative example in which the anode electrode 74 is free of an oxidation catalyst. In FIG. 10, it is assumed that nickel, which is a reforming catalyst, is oxidized to about NiOₓ: x=0.1 at the room temperature T_{RT}.

As indicated by the broken line in FIG. 10, in a case where the anode electrode 74 is free of the oxidation catalyst, even when the anode temperature T_{AN} exceeds the nickel oxidation temperature T_{OX} and transition to the second warm-up phase is performed, oxidation of nickel contained in the anode electrode 74 proceeds. Therefore, even when the anode temperature T_{AN} reaches the target temperature T_{target}, nickel contained in the anode electrode 74 may not sufficiently function as a reforming catalyst.

On the other hand, as indicated by the solid line in FIG. 10, heated air is circulated to the cathode 21 to start warm-up of the fuel cell stack 10 (fuel cell system 100). At this time, in the present embodiment, the heated air is also circulated to the anode 22. Since the oxidation of nickel contained in the anode electrode 74 hardly proceeds in a low-temperature range until the temperature reaches the nickel oxidation temperature T_{OX}, the warm-up proceeds more quickly by circulating the heated air also to the anode 22.

Thereafter, when the anode temperature T_{AN} reaches the nickel oxidation temperature T_{OX}, the first warm-up phase is switched to the second warm-up phase. That is, when the anode temperature T_{AN} reaches the nickel oxidation temperature T_{OX}, the mixture of the fuel and air is circulated to the anode 22. At this time, since the temperature exceeds the fuel oxidation temperature T_{FOS}, the fuel (methane) is oxidized by the action of the oxidation catalyst in the anode electrode 74, and the anode electrode 74 is directly heated. Accordingly, the warm-up proceeds with high energy efficiency.

In addition, while the anode temperature T_{AN} reaches the nickel reduction temperature T_{RED} from the nickel oxidation temperature T_{OX}, since the reduction power for nickel is not large as illustrated in FIG. 8, the oxidation of nickel proceeds. However, when the anode temperature T_{AN} exceeds the nickel reduction temperature T_{RED}, the reduction power for nickel rapidly increases, and nickel is reduced as the temperature rises. Further, when the temperature reaches the target temperature T_{target}, the nickel contained in the anode electrode 74 is sufficiently reduced to the extent that the nickel may function as a reforming catalyst. Therefore, with the warm-up control according to the present embodiment, the warm-up can be completed with high energy efficiency in a short period of time without impairing the function of nickel contained in the anode electrode 74 as a reforming catalyst.

Hereinafter, the warm-up control according to the present embodiment will be described in detail.

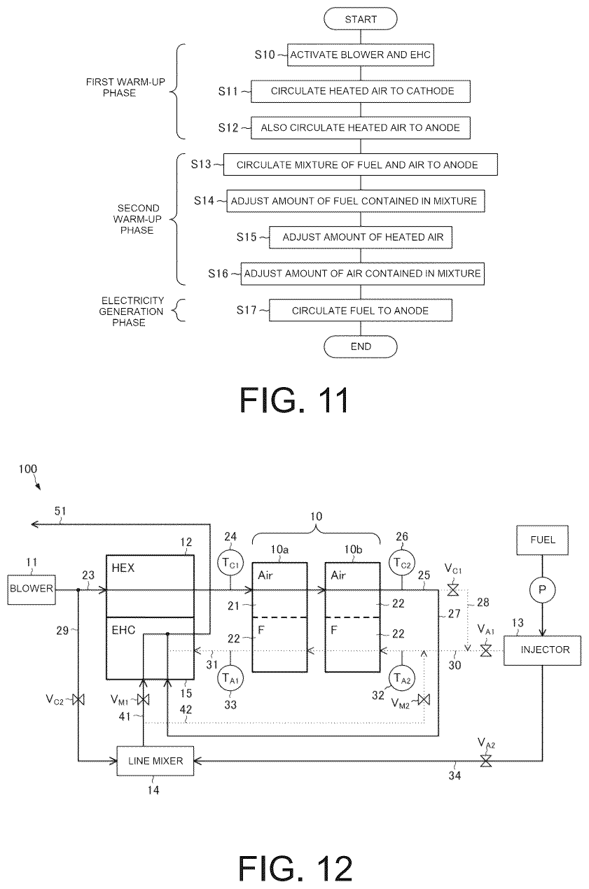

FIG. 11 is a flowchart of the warm-up control according to the present embodiment. As illustrated in FIG. 11, in step S10, the controller 16 activates the blower 11 and the combustor 15 and preheats the combustor 15.

In step S11, the controller 16 introduces the mixture of the fuel and the air into the combustor 15 by the line mixer 14, thereby circulating the heated air to the cathode 21 via the heat exchanger 12. That is, the controller 16 starts the first warm-up phase. Accordingly, the controller 16 heats the fuel cell stack 10 from the cathode 21 side.

In step S12, the controller 16 also causes the heated air to circulate to the anode 22. Accordingly, the controller 16 also heats the fuel cell stack 10 from the anode 22 side. In the present embodiment, since the outlet of the cathode 21 and the inlet of the anode 22 are coupled to each other by the second path 28 of the cathode discharge path 25, the heated air circulating through the cathode 21 is circulated to the anode 22 as it is. However, the present invention is not limited thereto, and for example, the outlet of the cathode 21 and a suction port of the blower 11 may be coupled to each other, and a flow path coupling the blower 11 and the anode 22 may be provided to allow the heated air circulating through the cathode 21 to circulate to the anode 22 via the blower 11.

In step S13, the controller 16 causes the mixture of the fuel and the air to circulate to the anode 22. That is, the controller 16 performs transition of the warm-up control from the first warm-up phase to the second warm-up phase. Accordingly, the oxidation reaction of the fuel occurs at the anode electrode 74 due to the action of the oxidation catalyst, and the anode electrode 74 is more directly heated. At the start of the second warm-up phase, a ratio (mixing ratio) of the fuel and the air contained in the mixture is determined in advance by experiment, simulation, or the like.

In step S14, the controller 16 adjusts an amount (concentration) of the fuel contained in the mixture circulated to the anode 22. Accordingly, a portion where the anode temperature T_{AN} exceeds the nickel oxidation temperature T_{OX} is sequentially expanded in the x-direction. In step S15, the controller 16 adjusts the amount (flow rate) of the heated air circulated to the cathode 21. Accordingly, the anode temperature T_{AN} along the x-direction is made uniform. In step S16, the controller 16 adjusts an amount (concentration) of air (oxygen) contained in the mixture circulated to the anode 22. Accordingly, the anode temperature T_{AN} is increased to the target temperature T_{target} while suppressing oxidation of nickel contained in the anode electrode 74.

Thereafter, in step S17, the controller 16 stops the circulation of the mixture to the anode 22 and causes the fuel to circulate to the anode 22. That is, the control of the controller 16 completes the warm-up control (ends second warm-up phase), and performs transition to an electricity generation phase in which the fuel cell stack 10 generates electricity.

FIG. 12 is a diagram illustrating a state of the fuel cell system 100 in step S11 of the first warm-up phase. In each of FIGS. 12 to 15, a path through which the heated air or the like circulates is indicated by a thick line, and a path through which the heated air or the like stops circulating is indicated by a dotted line. The controller 16 is not illustrated.

As illustrated in FIG. 12, in step S11, the controller 16 opens the valve V_{C2}, the valve V_{A1}, and the valve V_{M1}. Accordingly, the line mixer 14 introduces, into the combustor 15, the mixture of the air supplied by the blower 11 and the fuel supplied from the injector 13. The combustor 15 combusts the mixture, and the heat exchanger 12 heats the air circulated to the cathode 21 by heat generated in the combustor 15. That is, the controller 16 opens the valve V_{C2}, the valve V_{A1}, and the valve V_{M1} to cause the heated air to circulate to the cathode 21. In addition, the heated air circulating through the cathode 21 is guided to the combustor 15 via the first path 27 of the cathode discharge path 25, is used for the combustion reaction, and then is discharged from the fuel cell system 100.

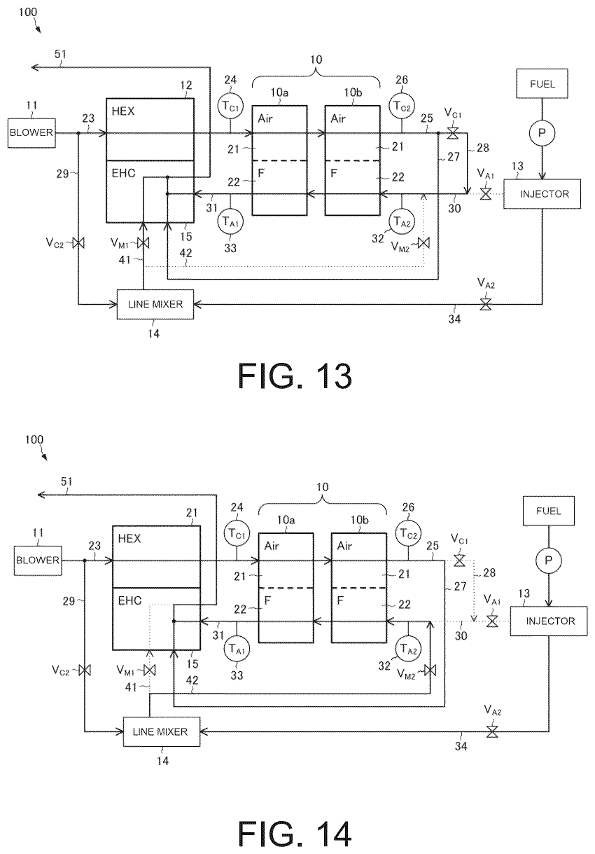

FIG. 13 is a diagram illustrating a state of the fuel cell system 100 in step S12 of the first warm-up phase. As illustrated in FIG. 13, in step S12, the controller 16 further opens the valve V_{C1}. Accordingly, at least a part of the heated air circulating through the cathode 21 is circulated to the anode 22 via the second path 28 of the cathode discharge path 25 and the first fuel supply path 30. The heated air circulating through the anode 22 is guided to the combustor 15 via the anode discharge path 31, is used for the combustion reaction, and then is discharged from the fuel cell system 100. When a valve (not illustrated) is provided in the first path 27 of the cathode discharge path 25, the controller 16 can close the valve to cause the entire heated air circulating through the cathode 21 to circulate to the anode 22.

FIG. 14 is a diagram illustrating a state of the fuel cell system 100 in the second warm-up phase. As illustrated in FIG. 14, in the second warm-up phase (steps S13 to S15), the controller 16 closes the valve V_{C1} and the valve V_{M1} and opens the valve V_{M2}. Accordingly, the heated air circulating through the cathode 21 is introduced into the combustor 15 via the first path 27 of the cathode discharge path 25. In addition, the mixture of the fuel and the air output from the line mixer 14 circulates through the anode 22 via the second mixture supply path 42, and is guided to the combustor 15 via the anode discharge path 31. Therefore, in the second warm-up phase, a state is implemented in which the heated air circulates through the cathode 21 and the mixture of the fuel and the air circulates through the anode 22.

In step S14, the controller 16 adjusts an opening degree of the valve V_{A2}, for example, to adjust the amount (concentration) of the fuel contained in the mixture circulated to the anode 22. In step S15, the controller 16 adjusts the output of the blower 11 to adjust the amount of heated air circulated to the cathode 21. In step S16, the controller 16 adjusts the opening degree of the valve V_{C2}, for example, to adjust the amount (concentration) of the air (oxygen) contained in the mixture circulated to the anode 22.

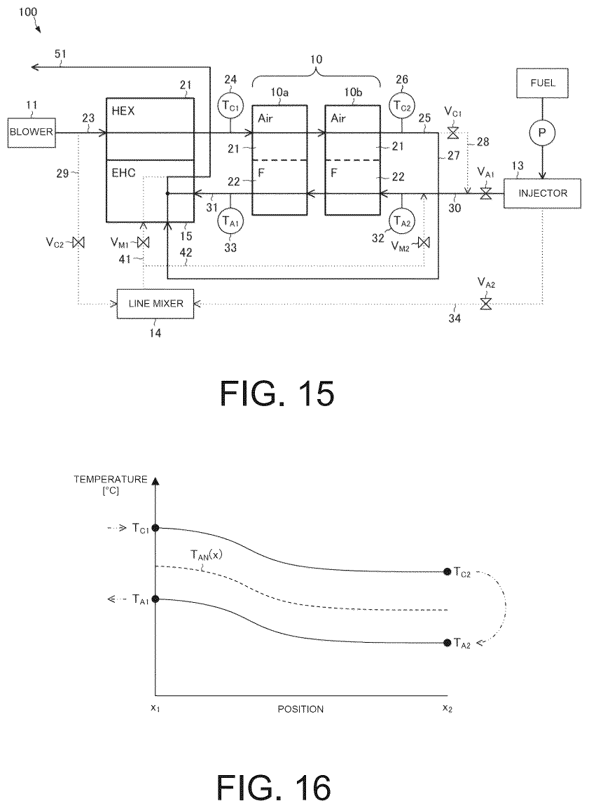

FIG. 15 is a diagram illustrating a state of the fuel cell system 100 in the electricity generation phase. As illustrated in FIG. 15, in the electricity generation phase (step S17), the controller 16 closes the valve V_{C2}, the valve V_{A2}, the valve V_{M1}, and the valve V_{M2}, and opens the valve V_{A1}. Accordingly, the heated air circulates through the cathode 21, and the fuel circulates through the anode 22. Accordingly, a chemical reaction for fuel reforming and electricity generation occurs in the fuel cell stack 10, and the fuel cell system 100 starts electricity generation. In addition, the cathode off gas and the anode off gas are introduced into the combustor 15.

Hereinafter, conditions and the like under which the controller 16 switches the first warm-up phase, the second warm-up phase, and the electricity generation phase will be described in detail.

The controller 16 determines a timing of transition from the first warm-up phase to the second warm-up phase by, for example, any of the following (a1) to (a3), or a combination of all or a part thereof.

(a1) The controller 16 estimates the temperature of the anode electrode 74 (anode temperature T_{AN}) based on the temperatures T_{C1} and T_{C2} of the heated air at the inlet and the outlet of the cathode 21 and the temperatures T_{A2} and T_{A1} of the heated air at the inlet and the outlet of the anode 22. Then, the controller 16 can determine the timing of transition from the first warm-up phase to the second warm-up phase based on the estimated anode temperature T_{AN}.

FIG. 16 is a graph schematically illustrating a temperature distribution of the fuel cell stack 10 in the first warm-up phase. In FIG. 16, solid lines indicate the temperature of the heated air circulating through the cathode 21 and the anode 22, and a broken line indicates the anode temperature T_{AN}. A two-dot chain line arrow indicates a flow of the heated air.

As illustrated in FIG. 16, since the heated air at the temperature T_{C1} is deprived of heat by the fuel cell stack 10 at the time of circulating through the cathode 21, at the outlet of the cathode 21, the heated air reaches the temperature T_{C2} lower than the temperature T_{C1} at the inlet of the cathode 21. In addition, the heated air circulating through the cathode 21 passes through the cathode discharge path 25 and the like, and thus reaches the temperature T_{A2} at the inlet of the anode 22. While heating the fuel cell stack 10 as a whole, the heated air circulating through the anode 22 is heated near the outlet of the anode 22 by the fuel cell stack 10 heated from the cathode 21 side. As a result, at the outlet of the anode 22, the heated air has a temperature T_{A1} higher than the temperature T_{A2} at the inlet of the anode 22.

At this time, the temperature distribution illustrated in (B) of FIG. 5 occurs in the z-direction of the fuel cell 60. Parameters such as an average thermal conductivity W_{cell} [m⁻¹K⁻¹] of the fuel cell 60, a thermal conductivity W_{cell-a} [m⁻¹K⁻¹] of the boundary film 81, a thermal conductivity W_{cell-b} [m⁻¹K⁻¹] of the boundary film 82, a thickness d_{ce} [m], and an area A [m²] of the cell are known at the time of designing the fuel cell 60. Therefore, the controller 16 can calculate (estimate) the anode temperature T_{AN} based on the temperature distribution along the x-direction of the heated air circulating through the cathode 21 and the temperature distribution along the x-direction of the heated air circulating through the anode 22. For example, in addition to the above parameters, the controller 16 can calculate the anode temperature T_{AN} at the inlet of the cathode 21 (outlet of anode 22) based on the temperature T_{C1} of the heated air at the inlet of the cathode 21 and the temperature T_{A2} of the heated air at the outlet of the anode 22 (in particular, temperature difference therebetween).

The temperature distribution along the x-direction of the heated air circulating through the cathode 21 is estimated based on the temperatures T_{C1} and T_{C2} of the heated air at the inlet and the outlet of the cathode 21, particularly a temperature difference therebetween. Similarly, the temperature distribution along the x-direction of the heated air circulating through the anode 22 is estimated based on the temperatures T_{A2} and T_{A1} of the heated air at the inlet and the outlet of the anode 22, particularly a temperature difference therebetween. Therefore, the controller 16 can estimate the anode temperature T_{AN} based on the temperatures T_{C1} and T_{C2} of the heated air at the inlet and the outlet of the cathode 21 and the temperatures T_{A2} and T_{A1} of the heated air at the inlet and the outlet of the anode 22.

In the present embodiment, the controller 16 more simply has a map in which the temperatures T_{C1} and T_{C2} of the heated air at the inlet and the outlet of the cathode 21 and the temperatures T_{A2} and T_{A1} of the heated air at the inlet and the outlet of the anode 22 are associated with the anode temperature T_{AN} at a specific position x between the position x₁ and the position x₂ (hereinafter, referred to as first temperature distribution map). The first temperature distribution map is created in advance by experiment, simulation, or the like. Then, the controller 16 refers to the first temperature distribution map to estimate the distribution of the anode temperature T_{AN} in the x-direction according to the temperatures T_{C1} and T_{C2} of the heated air at the inlet and the outlet of the cathode 21 and the temperatures T_{A2} and T_{A1} of the heated air at the inlet and the outlet of the anode 22.

Then, the controller 16 can determine the timing of transition from the first warm-up phase to the second warm-up phase based on the distribution of the anode temperature T_{AN} estimated as described above. Specifically, in principle, the controller 16 determines whether there is a portion where the temperature of the anode electrode 74 is equal to or higher than the nickel oxidation temperature T_{OX} based on the estimated distribution of the anode temperature T_{AN}. Then, when there is a portion where the temperature of the anode electrode 74 is equal to or higher than the nickel oxidation temperature T_{OX}, the controller 16 performs transition of the warm-up control from the first warm-up phase to the second warm-up phase.

Accordingly, the energy efficiency in the first warm-up phase can be improved and the warm-up can be completed earlier as a whole while preventing the anode electrode 74 from partially exceeding the nickel oxidation temperature T_{OX} and preventing the oxidation of nickel at that portion from proceeding deeply.

As described above, regarding the fuel oxidation temperature T_{FOS}, the fuel oxidation temperature T_{FOS} is lower than the nickel oxidation temperature T_{OX} because the anode electrode 74 contains an oxidation catalyst. Therefore, in the present embodiment, in order to more reliably prevent the partial oxidation of nickel from proceeding, the controller 16 determines the timing of transition from the first warm-up phase to the second warm-up phase based on the fuel oxidation temperature T_{FOS} instead of the nickel oxidation temperature T_{OX}.

(a2) The controller 16 detects the cell resistance Rₓ and estimates the anode temperature T_{AN} based on the detected cell resistance Rₓ. Then, the controller 16 can determine the timing of transition from the first warm-up phase to the second warm-up phase based on the estimated anode temperature T_{AN}.

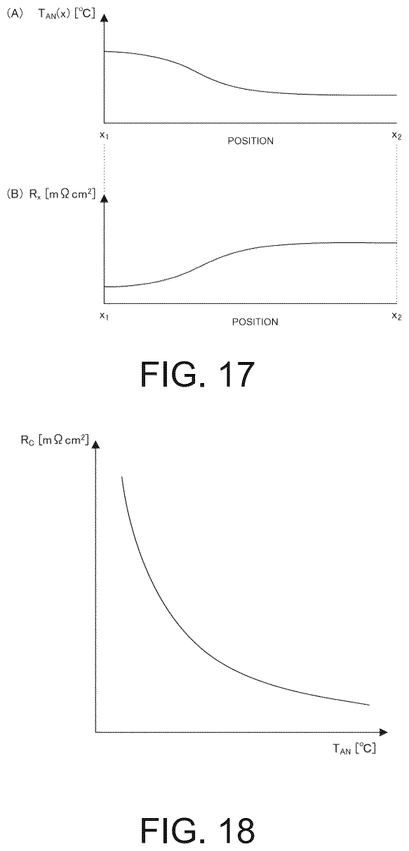

FIG. 17 is a graph illustrating a schematic distribution of the anode temperature T_{AN} and the cell resistance Rₓ in the first warm-up phase. (A) of FIG. 17 illustrates a distribution of the anode temperature T_{AN} along the x-direction. (B) of FIG. 17 illustrates a distribution of the cell resistance Rₓ [mΩcm²] along the x-direction. FIG. 18 is a graph schematically illustrating the relation between the anode temperature T_{AN} and the cell resistance Rₓ in the first warm-up phase.

In the first warm-up phase, since the fuel cell stack 10 is heated by the heated air circulated to the cathode 21, the anode temperature T_{AN} is high on an inlet side (position x₁) of the cathode 21 and is low on an outlet side (position x₂) of the cathode 21, as illustrated in (A) of FIG. 17. At this time, as illustrated in (B) of FIG. 17, contrary to the anode temperature T_{AN}, the cell resistance Rₓ is low on the inlet side of the cathode 21 and is high on the outlet side of the cathode 21. This is because the higher the anode temperature T_{AN}, the higher a temperature of the solid electrolyte 61 and the higher an ion conductivity thereof. That is, as illustrated in FIG. 18, the anode temperature T_{AN} is substantially inversely proportional to the cell resistance Rₓ.

In the present embodiment, the controller 16 has a second temperature distribution map in which the cell resistance Rₓ and the anode temperature T_{AN} are associated with each other in advance by experiment, simulation, or the like. Therefore, the controller 16 detects the cell resistance Rₓ at the position x and refers to the second temperature distribution map to calculate the anode temperature T_{AN} at the position x. As a result, the controller 16 can estimate the distribution of the anode temperature T_{AN} along the x-direction.

Then, the controller 16 determines the timing of transition from the first warm-up phase to the second warm-up phase based on the distribution of the anode temperature T_{AN} estimated as described above. A specific method for determining the timing of transition from the first warm-up phase to the second warm-up phase based on the estimated distribution of the anode temperature T_{AN} is the same as (a1).

(a3) The controller 16 can determine the timing of transition from the first warm-up phase to the second warm-up phase based on the temperature T_{A1} of the heated air at the outlet of the anode 22.

In the present embodiment, the fuel cell stack 10 has a counterflow structure. Therefore, as illustrated in FIGS. 16 and (A) of 17, the temperature of the heated air in the anode 22 is distributed in the x-direction similarly to the anode temperature T_{AN}. Therefore, the temperature T_{A1} of the heated air at the outlet of the anode 22 is a temperature corresponding to a maximum value of the anode temperature T_{AN}. Therefore, here, the controller 16 simply regards the temperature T_{A1} of the heated air at the outlet of the anode 22 as the maximum value of the anode temperature T_{AN}. Then, the controller 16 executes the first warm-up phase within a range in which the temperature T_{A1} of the heated air at the outlet of the anode 22 does not exceed the nickel oxidation temperature T_{OX}. That is, the controller 16 performs transition of the warm-up control from the first warm-up phase to the second warm-up phase when the temperature T_{A1} of the heated air at the outlet of the anode 22 is equal to or higher than the nickel oxidation temperature T_{OX}. In this way, the first warm-up phase can be executed within a range in which the anode temperature T_{AN} does not reliably exceed the nickel oxidation temperature T_{OX}.

As described above, regarding the fuel oxidation temperature T_{FOS}, the fuel oxidation temperature T_{FOS} is lower than the nickel oxidation temperature T_{OX} because the anode electrode 74 contains the oxidation catalyst. Therefore, in the present embodiment, in order to more reliably prevent the oxidation of nickel from proceeding, the controller 16 determines the transition timing from the first warm-up phase to the second warm-up phase based on the fuel oxidation temperature T_{FOS} instead of the nickel oxidation temperature T_{OX}. That is, the controller 16 causes the heated air to circulate to the anode 22 while the temperature T_{A1} of the heated air at the outlet of the anode 22 is lower than the fuel oxidation temperature T_{FOS} to execute the first warm-up phase. Further, when the temperature T_{A1} of the heated air at the outlet of the anode 22 is equal to or higher than the fuel oxidation temperature T_{FOS}, the controller 16 performs transition of the warm-up control from the first warm-up phase to the second warm-up phase.

The above methods (a1) to (a3) related to determination on the transition from the first warm-up phase to the second warm-up phase can also be applied to a case where the fuel cell stack 10 has a parallel flow structure.

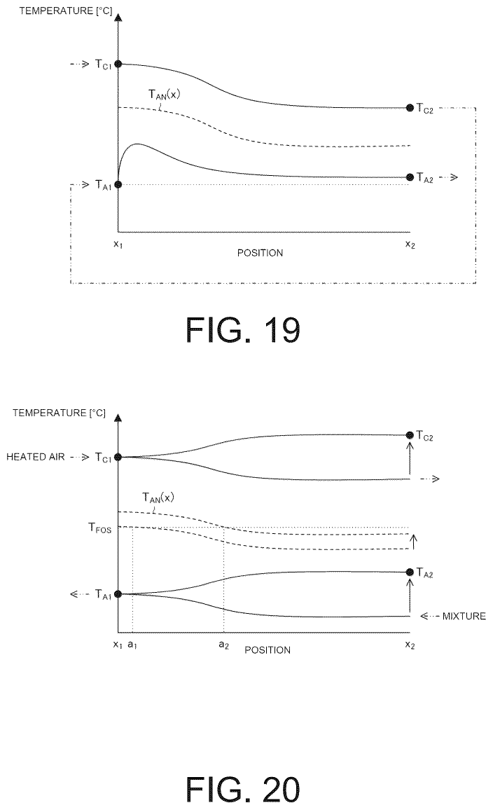

FIG. 19 is a graph schematically illustrating a temperature distribution occurring in the first warm-up phase when the fuel cell stack 10 has a parallel flow structure. In FIG. 19, solid lines indicate the temperature of the heated air circulating through the cathode 21 and the anode 22, and a broken line indicates the anode temperature T_{AN}. A two-dot chain line arrow indicates a flow of the heated air.

As illustrated in FIG. 19, even when the fuel cell stack 10 has a parallel flow structure, the temperature distribution of the heated air circulating through the cathode 21 is the same as that when the fuel cell stack 10 has a counterflow structure. On the other hand, when the fuel cell stack 10 has a parallel flow structure, the inlet of the anode 22 is at the position x₁, and the outlet of the anode 22 is at the position x₂. Therefore, when the fuel cell stack 10 has a parallel flow structure, the temperature of the heated air circulating through the anode 22 rapidly increases near the position x₁ and gradually decreases as the heated air circulates through the anode 22.

However, as illustrated in FIG. 19, the temperatures T_{C1} and T_{C2} of the heated air at the inlet and the outlet of the cathode 21 and the temperatures T_{A1} and T_{A2} of the heated air at the inlet and the outlet of the anode 22 are still correlated with the anode temperature T_{AN}. Therefore, even when the fuel cell stack 10 has a parallel flow structure, the first temperature distribution map can be created by associating, in advance by experiment, simulation, or the like, the temperatures T_{C1} and T_{C2} of the heated air at the inlet and the outlet of the cathode 21 and the temperatures T_{A1} and T_{A2} of the heated air at the inlet and the outlet of the anode 22 with the anode temperature T_{AN} at a specific position x between the position x₁ and the position x₂. Therefore, even when the fuel cell stack 10 has a parallel flow structure, the controller 16 can estimate the anode temperature T_{AN} by the same method as (a1), and determine the timing of transition from the first warm-up phase to the second warm-up phase based on the estimated anode temperature T_{AN}.

A relation between the cell resistance Rₓ and the anode temperature T_{AN} does not depend on whether the fuel cell stack 10 has a counterflow structure or a parallel flow structure. Therefore, even when the fuel cell stack 10 has a parallel flow structure, the controller 16 can estimate the anode temperature T_{AN} by the same method as in (a2), and determine the timing of transition from the first warm-up phase to the second warm-up phase based on the estimated anode temperature T_{AN}.

When the fuel cell stack 10 has a parallel flow structure, since the outlet of the anode 22 is at the position x₂, the heated air at the outlet of the anode 22 has the temperature T_{A2} illustrated in FIG. 19. Therefore, when the fuel cell stack 10 has a parallel flow structure, the temperature T_{A2} of the heated air at the outlet of the anode 22 cannot be directly regarded as the maximum value of the anode temperature T_{AN}. However, there is still a certain correlation between the temperature T_{A2} of the heated air at the outlet of the anode 22 and the maximum value of the anode temperature T_{AN}. Therefore, in a case where the fuel cell stack 10 has a parallel flow structure, when a map that associates the temperature T_{A2} of the heated air at the outlet of the anode 22 with the maximum value of the anode temperature T_{AN} is prepared by experiment, simulation, or the like, the controller 16 can refer to the map to calculate (estimate) the temperature T_{A2} of the heated air at the outlet of the anode 22 and the maximum value of the anode temperature T_{AN}. Therefore, the controller 16 can estimate the anode temperature T_{AN} based on the temperature T_{A2} of the heated air at the outlet of the anode 22 similarly to (a3), and determine the timing of transition from the first warm-up phase to the second warm-up phase based on the estimated anode temperature T_{AN}.

The controller 16 executes the second warm-up phase (steps S14 to S16) by, for example, the following method.

FIG. 20 is a diagram illustrating an effect of step S14 in the second warm-up phase. In FIG. 20, solid lines indicate the temperature distribution of the heated air circulating through the cathode 21 and the temperature distribution of the mixture circulating through the anode 22. In FIG. 20, broken lines indicate the distribution of the anode temperature T_{AN} along the x-direction. In FIG. 20, two-dot chain line arrows indicate the circulation direction of the heated air in the cathode 21 and the circulation direction of the mixture in the anode 22. In addition, in FIG. 20, solid line arrows indicate the direction of change due to an increase in the fuel contained in the mixture circulated to the anode 22.

In step S14 of the second warm-up phase, as described above, the controller 16 adjusts the amount (concentration) of the fuel contained in the mixture circulated to the anode 22. More specifically, when performing transition to the second warm-up phase, the controller 16 increases the amount (concentration) of the fuel contained in the mixture circulated to the anode 22. When the fuel contained in the mixture circulated to the anode 22 increases, a portion (range) where the anode temperature T_{AN} is equal to or higher than the fuel oxidation temperature T_{FOS} is expanded.

For example, as illustrated in FIG. 20, after performing transition to the second warm-up phase, the portion where the anode temperature T_{AN} is equal to or higher than the fuel oxidation temperature T_{FOS} is a portion from the position x₁ to a position a₁ before the fuel contained in the mixture is increased. In this state, when the fuel contained in the mixture circulated to the anode 22 is increased, the oxidation reaction of the fuel increases in the portion from the position x₁ to the position a₁, where the anode temperature T_{AN} is equal to or higher than the fuel oxidation temperature T_{FOS}, and the anode electrode 74 generates more heat. Further, the heat generated in the anode electrode 74 is directly conducted to the anode electrode 74 and the like. Therefore, the portion where the anode temperature T_{AN} is equal to or higher than the fuel oxidation temperature T_{FOS} spreads to the position x₂ side earlier than the case where the heated air is simply circulated to the cathode 21, and is expanded to, for example, a range from the position x₁ to a position a₂.

In the portion where the anode temperature T_{AN} is equal to or higher than the fuel oxidation temperature T_{FOS}, an oxidation reaction of the fuel occurs, and the anode electrode 74 directly generates heat. Therefore, the heated air circulating through the cathode 21 tends to be heated by the heat generated by the oxidation reaction of the fuel in the portion where the anode temperature T_{AN} is equal to or higher than the fuel oxidation temperature T_{FOS}. Similarly, the mixture circulating through the anode 22 tends to be heated by the heat generated by the oxidation reaction of the fuel in the portion where the anode temperature T_{AN} is equal to or higher than the fuel oxidation temperature T_{FOS}. Therefore, when the fuel contained in the mixture is increased, the temperature T_{C2} of the heated air at the outlet of the cathode 21 rises. As a result, the temperature distribution of the mixture circulating through the anode 22 substantially follows the above rise, and the temperature T_{A2} of the mixture at the inlet of the anode 22 rises.

In particular, when the portion where the anode temperature T_{AN} is equal to or higher than the fuel oxidation temperature T_{FOS} spreads substantially entirely from the position x₁ to the position x₂, the temperature T_{C2} of the heated air at the outlet of the cathode 21 is higher than the temperature T_{C1} of the heated air at the inlet of the cathode 21. Similarly, when the portion where the anode temperature T_{AN} is equal to or higher than the fuel oxidation temperature T_{FOS} spreads substantially entirely from the position x₁ to the position x₂, the temperature T_{A2} of the mixture at the inlet of the anode 22 is higher than the temperature T_{A1} of the mixture at the outlet of the anode 22.

Therefore, in the second warm-up phase (step S14), the controller 16 increases the fuel contained in the mixture based on the temperatures T_{C1} and T_{C2} of the heated air at the inlet and the outlet of the cathode 21 and/or the temperatures T_{A2} and T_{A1} of the mixture at the inlet and the outlet of the anode 22.

Specifically, the controller 16 can increase the fuel contained in the mixture until the temperature T_{C2} of the heated air at the outlet of the cathode 21 is equal to or higher than the temperature T_{C1} of the heated air at the inlet of the cathode 21, or until the temperature T_{A2} of the mixture at the outlet of the anode 22 is equal to or higher than the temperature T_{A1} of the mixture at the inlet of the anode 22. In addition, the controller 16 can increase the fuel contained in the mixture until the temperature T_{C2} of the heated air at the outlet of the cathode 21 is equal to or higher than the temperature T_{C1} of the heated air at the inlet of the cathode 21 and the temperature T_{A2} of the mixture at the outlet of the anode 22 is equal to or higher than the temperature T_{A1} of the mixture at the inlet of the anode 22.

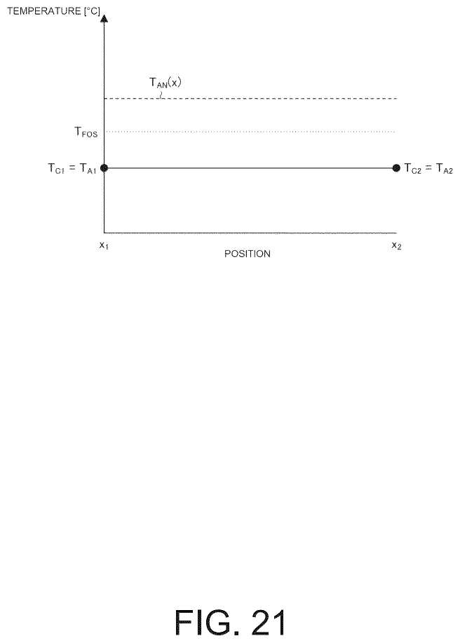

FIG. 21 is a diagram illustrating an effect of step S15 in the second warm-up phase. As described above, when the flow rate of the heated air circulated to the cathode 21 is further adjusted after the fuel of the mixture circulating through the anode 22 is adjusted in step S14, the temperature distribution (particularly, distribution of anode temperature T_{AN}) in the fuel cell stack 10 can be made uniform as illustrated in FIG. 21. That is, the controller 16 reduces a temperature difference (|T_{C1}−T_{C2}|) of the heated air at the inlet and the outlet of the cathode 21 by adjusting the flow rate of the heated air circulated to the cathode 21 after increasing the fuel contained in the mixture.

Specifically, when the fuel of the mixture circulating through the anode 22 is increased and the temperature of the fuel cell stack 10 rises as a whole, the anode temperature T_{AN} exceeds the temperature (temperature T_{C1}) of the heated air. Therefore, in the second warm-up phase (step S15), the controller 16 increases the flow rate of the heated air circulated to the cathode 21, for example, by adjusting the output of the blower 11. Accordingly, the temperature distribution in the fuel cell stack 10 is made substantially uniform.

In the second warm-up phase (step S16), the controller 16 reduces the air contained in the mixture. Specifically, the controller 16 estimates the anode temperature T_{AN}, and reduces the air contained in the mixture when the estimated anode temperature T_{AN} is equal to or higher than the nickel oxidation temperature T_{OX} in at least a part of the x-direction. Accordingly, the controller 16 causes the fuel-rich mixture to circulate to the anode 22. As a result, the portion where the anode temperature T_{AN} is equal to or higher than the fuel oxidation temperature T_{FOS} is expanded to the position x₂ while suppressing the proceeding of oxidation of nickel contained in the anode electrode 74.

In the second warm-up phase (step S16), the method by which the controller 16 estimates the anode temperature T_{AN} is the same as the estimation method in (a1) to (a3) described above or a combination thereof.

However, when the estimation method (a1) is used, the controller 16 uses a third temperature distribution map instead of the first temperature distribution map described above. The third temperature distribution map is a map in which the temperatures T_{C1} and T_{C2} of the heated air at the inlet and the outlet of the cathode 21 and the temperature T_{A2} and T_{A1} of the heated air at the inlet and the outlet of the anode 22 are associated with the anode temperature T_{AN} at the specific position x between the position x₁ and the position x₂ in a situation in which the anode electrode 74 starts direct heat generation due to the oxidation reaction of the fuel. That is, the third temperature distribution map is a map in which the temperatures T_{C1}, T_{C2}, T_{A2}, and T_{A1} are associated with the anode temperature T_{AN} at the specific position x when the temperature distribution of the fuel cell 60 in the z-direction has a portion in the situation as illustrated in (C) of FIG. 5. The third temperature distribution map is obtained in advance by experiment, simulation, or the like.

In the second warm-up phase, since the mixture circulates through the anode 22, when the estimation method (a3) is used, the controller 16 simply regards the temperature T_{A1} of the mixture at the outlet of the anode 22 as the maximum value of the anode temperature T_{AN}.

At the time of reducing the air (oxygen) contained in the mixture in the second warm-up phase (step S16), the controller 16 can adjust the amount (concentration) of the air (oxygen) contained in the mixture by, for example, the following method (b1) or (b2) or a combination thereof.

(b1) The controller 16 can estimate an oxygen utilization rate at the anode 22 based on a time change rate of the combustor temperature T_{b} (hereinafter referred to as temperature change rate ΔT_{b}), and adjust the amount of air (oxygen) contained in the mixture based on the estimated oxygen utilization rate.

Specifically, the controller 16 calculates (estimates) the temperature change rate ΔT_{b} of the combustor 15 based on the combustor temperature T_{b} when the fuel contained in the mixture starts to be increased in step S14 (hereinafter referred to as initial combustor temperature T_{b1}) and the combustor temperature T_{b} when the amount of air contained in the mixture is adjusted in step S16 (hereinafter referred to as current combustor temperature T_{b}).

When the combustor temperature T_{b} rises after step S14, the temperature rise is caused by unburned fuel (hereinafter referred to as unburned fuel), which is discharged without being oxidized at the anode electrode 74 due to the increase in the fuel contained in the mixture in step S14, being combusted in the combustor 15. Therefore, the controller 16 calculates (estimates) the amount of heat generated from the unburned fuel in the combustor 15 (hereinafter referred to as amount of heat of unburned fuel).

In addition, the supply amount of the fuel to the anode 22 by the mixture is known. Therefore, the controller 16 calculates the amount of heat generated when the supplied fuel is completely oxidized (hereinafter referred to as amount of heat of complete oxidation) based on the supply amount of the fuel to the anode 22 by the mixture.

Then, the controller 16 calculates (estimates) the oxygen utilization rate at the anode 22 based on a difference between the amount of heat of the unburned fuel and the amount of heat of complete oxidation. The controller 16 can also calculate (estimate) a fuel utilization rate at the anode 22 based on the difference between the amount of heat of the unburned fuel and the amount of heat of complete oxidation. In the present embodiment, the controller 16 calculates the oxygen utilization rate at the anode 22 and reduces the amount of air contained in the mixture such that the oxygen utilization rate is equal to or more than a predetermined threshold. Accordingly, the controller 16 reduces the amount of air contained in the mixture such that almost all oxygen is used for the oxidation reaction of the fuel at the anode electrode 74.

The predetermined threshold for the oxygen utilization rate (oxygen utilization rate threshold) is set to, for example, 99% such that almost all oxygen contained in the mixture is used for the oxidation reaction of the fuel at the anode electrode 74. In addition, in step S16, even when the anode off gas is substantially free of oxygen, the heated air circulating through the cathode 21 is introduced into the combustor 15, and thus the combustion reaction in the combustor 15 is not hindered.

(b2) As described above, an oxygen concentration in the anode off gas may be appropriately detected by the oxygen concentration sensor (not illustrated) provided in the anode discharge path 31. Therefore, the controller 16 can detect the oxygen concentration in the anode off gas and adjust the amount of air contained in the mixture based on the detected oxygen concentration.

Specifically, the controller 16 reduces the amount of air contained in the mixture such that the oxygen concentration in the anode off gas is equal to or less than a predetermined threshold. Accordingly, the controller 16 reduces the amount of air contained in the mixture such that almost all oxygen is used for the oxidation reaction of the fuel at the anode electrode 74.

The predetermined threshold for the oxygen concentration in the anode off gas (oxygen concentration threshold) is set to, for example, 1 ppm such that almost all oxygen contained in the mixture is used for the oxidation reaction of the fuel at the anode electrode 74. As described above, even when the anode off gas is substantially free of oxygen, the combustion reaction in the combustor 15 is not hindered.

The controller 16 can determine the timing of transition from the second warm-up phase to the electricity generation phase by, for example, the following method.

Specifically, in principle, the controller 16 continues the second warm-up phase until the anode temperature T_{AN} is equal to or higher than the nickel reduction temperature T_{RED} in all or part of the x-direction. When the anode temperature T_{AN} is equal to or higher than the nickel reduction temperature T_{RED}, the controller 16 performs transition of the control of the fuel cell system 100 from the second warm-up phase to the electricity generation phase. Accordingly, even when all or a part of nickel contained in the anode electrode 74 is deeply oxidized, the controller 16 reliably reduces the nickel and causes the nickel to function as a reforming catalyst in the subsequent electricity generation phase.

In the present embodiment, the controller 16 estimates the anode temperature T_{AN} at the inlet, the outlet, or the inlet and the outlet of the cathode 21, and continues the second warm-up phase until the estimated anode temperature T_{AN} is equal to or higher than the nickel reduction temperature T_{RED}.

For example, the controller 16 estimates the anode temperature T_{AN} (x₁) at the inlet of the cathode 21 (outlet of anode 22) based on the temperature T_{C1} of the heated air at the inlet of the cathode 21 and the temperature T_{A2} of the mixture at the outlet of the anode 22. When the anode temperature T_{AN} (x₁) at the inlet of the cathode 21 is equal to or higher than the nickel reduction temperature T_{RED}, transition of the control of the fuel cell system 100 from the second warm-up phase to the electricity generation phase can be performed.

As illustrated in FIG. 16 and the like, the anode temperature T_{AN} tends to increase at the inlet (position x₁) of the cathode 21 from the first warm-up phase to the second warm-up phase. Therefore, the anode electrode 74 near the inlet of the cathode 21 is more easily oxidized than other portions until the second warm-up phase is completed. Therefore, when the anode temperature T_{AN} (x₁) at the inlet of the cathode 21 is equal to or higher than the nickel reduction temperature T_{RED}, it can be considered that the nickel of substantially the entire anode electrode 74 is in a state of being sufficiently reduced. Therefore, as described above, by determining the timing of transition from the second warm-up phase to the electricity generation phase, the controller 16 can execute the electricity generation phase in a state where the nickel contained in the anode electrode 74 is substantially reliably reduced and a state where the nickel may sufficiently function as a reforming catalyst is secured.

The controller 16 estimates the anode temperature T_{AN} (x₂) at the outlet of the cathode 21 (inlet of anode 22) based on the temperature T_{C2} of the heated air at the outlet of the cathode 21 and the temperature T_{A2} of the mixture at the inlet of the anode 22. When the anode temperature T_{AN} (x₂) at the outlet of the cathode 21 is equal to or higher than the nickel reduction temperature T_{RED}, transition of the control of the fuel cell system 100 from the second warm-up phase to the electricity generation phase can be performed.

As illustrated in FIG. 16 and the like, the anode temperature T_{AN} tends to be low at the outlet (position x₂) of the cathode 21 from the first warm-up phase to the second warm-up phase. Therefore, the anode electrode 74 near the outlet of the cathode 21 is less likely to be reduced than other portions until the second warm-up phase is completed. Therefore, when the anode temperature T_{AN} (x₂) at the outlet of the cathode 21 is equal to or higher than the nickel reduction temperature T_{RED}, it can be considered that the nickel of substantially the entire anode electrode 74 is in a state of being sufficiently reduced. Therefore, as described above, by determining the timing of transition from the second warm-up phase to the electricity generation phase, the controller 16 can execute the electricity generation phase in a state where the nickel contained in the anode electrode 74 is substantially reliably reduced and a state where the nickel may sufficiently function as a reforming catalyst is secured.

Similarly to the above, the controller 16 can estimate the anode temperature T_{AN} (x₁) at the inlet of the cathode 21 and the anode temperature T_{AN} (x₂) at the outlet of the cathode 21, and perform transition of the control of the fuel cell system 100 from the second warm-up phase to the electricity generation phase when both of these temperatures are equal to or higher than the nickel reduction temperature T_{RED}. In this way, by determining the timing of transition from the second warm-up phase to the electricity generation phase, the controller 16 can execute the electricity generation phase in a state where substantially all of the nickel contained in the anode electrode 74 is particularly reliably reduced and a state where the nickel may sufficiently function as a reforming catalyst is secured.

When determining the timing of transition from the second warm-up phase to the electricity generation phase, the controller 16 can estimate the anode temperature T_{AN} according to the methods (a1) to (a3) as in the estimation method of the anode temperature T_{AN} in step S16 described above. In the present embodiment, the fuel cell stack 10 has a counterflow structure, but when the fuel cell stack 10 has a parallel flow structure, the controller 16 can also determine the timing of transition from the second warm-up phase to the electricity generation phase in the same manner as described above.

As described above, the control method for a fuel cell system according to the above embodiment is a control method for the fuel cell system 100 including a solid oxide fuel cell stack (10) that uses a hydrocarbon-based fuel as a fuel and that contains, at the anode 22, a reforming catalyst (nickel or the like) for reforming the fuel and an oxidation catalyst (platinum or the like) for oxidizing the fuel. The control method including warming up the fuel cell system 100 by a first warm-up phase in which heated air is circulated at least to the cathode 21 to warm up the fuel cell system using heat of the heated air, and a second warm-up phase in which, after the first warm-up phase, a mixture of the fuel and air is introduced into the anode 22, the fuel is oxidized by the oxidation catalyst, and warm-up is performed using heat generated by an oxidation reaction of the fuel.

In the second warm-up phase, the oxidation reaction of the fuel occurs at the anode electrode 74 due to the action of the oxidation catalyst, and the anode electrode 74 is directly heated by the heat. Therefore, as described above, by executing the second warm-up phase, the warm-up can be completed in a shorter period of time with higher energy efficiency than in the case where the fuel cell system 100 (fuel cell stack 10) is continuously warmed up by the first warm-up phase. In addition, in the case of using a hydrocarbon-based fuel, when air (oxygen) is circulated to the anode 22, the reforming catalyst is oxidized, and thereafter, there is a possibility that the reforming catalyst does not function as a reforming catalyst, but in the second warm-up phase, reduction of the reforming catalyst proceeds due to the action of the oxidation catalyst, so that the warm-up can be performed while maintaining the function of the reforming catalyst. That is, with the control method for a fuel cell system according to the above embodiment, it is possible to complete the warm-up in a shorter period of time with higher energy efficiency than in the related art while maintaining the function of the reforming catalyst contained in the anode 22.

In the control method for a fuel cell system according to the above embodiment, the heated air is also circulated to the anode 22 in the first warm-up phase.

In this way, in the first warm-up phase, the fuel cell stack 10 is heated not only from a cathode 21 side but also from an anode 22 side by also circulating the heated air to the anode 22. Therefore, the warm-up can be completed in a shorter period of time with higher energy efficiency than in the related art.

In the control method for a fuel cell system according to the above embodiment, the heated air circulated to the anode 22 is the heated air discharged from the cathode 21.

In this way, when the heated air discharged from the cathode 21 is circulated to the anode 22, the warm-up can be completed particularly in a short period of time with high energy efficiency.

In the control method for a fuel cell system according to the above embodiment, an temperature (T_{AN}) of the anode 22 is estimated based on the temperatures T_{C1} and T_{C2} of the heated air at an inlet and an outlet of the cathode 21 and the temperatures T_{A2} and T_{A1} of the heated air at an inlet and an outlet of the anode 22. Then, a timing of transition from the first warm-up phase to the second warm-up phase is determined based on the estimated anode temperature (T_{AN}).

In this way, by determining the timing of transition from the first warm-up phase to the second warm-up phase based on the anode temperature T_{AN}, the energy efficiency of the first warm-up phase can be improved while preventing oxidation of the reforming catalyst, and warm-up completion can be advanced as a whole.

In the control method for a fuel cell system according to the above embodiment, an electrical resistance (Rₓ) between the cathode 21 and the anode 22 is detected, and a temperature (T_{AN}) of the anode is estimated based on the electrical resistance. Then, a timing of transition from the first warm-up phase to the second warm-up phase is determined based on the estimated anode temperature (T_{AN}).

In this way, the anode temperature T_{AN} can be estimated based on the electrical resistance (cell resistance Rₓ). In this case, similarly as described above, by determining the timing of transition from the first warm-up phase to the second warm-up phase based on the anode temperature T_{AN}, the energy efficiency in the first warm-up phase can also be improved while preventing oxidation of the reforming catalyst, and warm-up completion can also be advanced as a whole.

In the control method for a fuel cell system according to the above embodiment, in the first warm-up phase, the heated air is circulated to the anode facing the heated air circulated to the cathode 21, and a temperature (T_{A1}) of the heated air at an outlet of the anode 22 is detected. Then, the heated air is circulated to the anode while the temperature (T_{A1}) of the heated air at the outlet of the anode 22 is lower than the fuel oxidation temperature T_{FO}S at which oxidation of the fuel is started by the oxidation catalyst, and transition from the first warm-up phase to the second warm-up phase is performed when the temperature (T_{A1}) of the heated air at the outlet of the anode 22 is equal to or higher than the fuel oxidation temperature T_{FOS}.

When the fuel cell stack 10 has a counterflow structure, as described above, the timing of transition to the second warm-up phase can be easily and accurately determined based on the temperature (T_{A2}) of the heated air at the outlet of the anode 22. That is, the first warm-up phase can be executed in a temperature range in which the anode temperature T_{AN} hardly exceeds the nickel oxidation temperature T_{OX}.

In the control method for a fuel cell system according to the above embodiment, in the second warm-up phase, the fuel contained in the mixture is increased until a temperature (T_{C2}) of the heated air at an outlet of the cathode 21 is equal to or higher than a temperature (T_{C1}) of the heated air at an inlet of the cathode 21.

In this way, by increasing the fuel contained in the mixture in the second warm-up phase, a portion where the anode temperature T_{AN} is equal to or higher than the fuel oxidation temperature T_{FOS}, that is, a range in which the anode electrode 74 is directly heated is expanded at an early stage. Therefore, the warm-up completion is advanced.

In the control method for a fuel cell system according to the above embodiment, a temperature difference of the heated air at the inlet and the outlet of the cathode 21 is reduced by adjusting a flow rate of the heated air circulated to the cathode 21 after increasing the fuel contained in the mixture.

In this way, when the flow rate of the heated air circulated to the cathode 21 is adjusted after the fuel contained in the mixture is increased, the temperature of the fuel cell stack 10 such as the anode temperature T_{AN} is made uniform. As a result, problems such as oxidation of the reforming catalyst proceeding in a part of the anode electrode 74 are prevented.

In the control method for a fuel cell system according to the embodiment, in the second warm-up phase, a temperature (T_{AN}) of the anode 22 is estimated, and an amount of the air contained in the mixture is reduced when at least a part of the anode 22 is equal to or higher than a reforming catalyst oxidation temperature (T_{OX}), which is a temperature at which oxidation of the reforming catalyst is started.

In this way, by reducing the amount of the air contained in the mixture circulated to the anode 22, it is possible to expand a portion where the anode electrode 74 is directly heated while suppressing the proceeding of oxidation of the reforming catalyst.

In the control method for a fuel cell system according to the above embodiment, a gas discharged from the anode 22 (anode off gas) is combusted in the combustor 15. Then, an oxygen utilization rate at the anode 22 is estimated based on the temperature change rate ΔT_{b} of the combustor 15, and the amount of the air contained in the mixture is adjusted based on the estimated oxygen utilization rate.

In this way, by adjusting the amount of the air contained in the mixture based on the oxygen utilization rate, it is possible to expand the portion where the anode electrode 74 is directly heated while particularly reliably suppressing proceeding of oxidation of the reforming catalyst.

In the control method for a fuel cell system according to the above embodiment, an oxygen concentration in a gas discharged from the anode 22 (anode off gas) is detected, and the amount of the air contained in the mixture is adjusted based on the detected oxygen concentration.

In this way, even when the amount of the air contained in the mixture is adjusted based on the oxygen concentration in the anode off gas, the portion where the anode electrode 74 that is directly heated can be enlarged while particularly reliably suppressing the proceeding of oxidation of the reforming catalyst.

In the control method for a fuel cell system according to the above embodiment, a temperature (T_{AN}) of the anode 22 is estimated at an inlet of the cathode 21, an outlet of the cathode 21, or the inlet and the outlet of the cathode 21, and the second warm-up phase is continued until the estimated temperature (T_{AN}) of the anode 22 is equal to or higher than a reduction temperature (T_{RED}) of the reforming catalyst in presence of the oxidation catalyst.

In this way, by continuing the second warm-up phase until the anode temperature T_{AN} is equal to or higher than the nickel reduction temperature T_{RED}, nickel contained in the anode electrode 74 is substantially reliably reduced. Therefore, the electricity generation phase can be executed in a state of securing a state where nickel contained in the anode electrode 74 may sufficiently function as a reforming catalyst.

A control device for the fuel cell system according to the above embodiment is a control device (controller 16) of the fuel cell system 100 including a solid oxide fuel cell stack (10) that uses a hydrocarbon-based fuel as a fuel and that contains, at the anode 22, a reforming catalyst (nickel or the like) for reforming the fuel and an oxidation catalyst (platinum or the like) for oxidizing the fuel. The control device warms up the fuel cell system 100 by a first warm-up phase in which heated air is circulated at least to the cathode 21 to warm up the fuel cell system using heat of the heated air, and a second warm-up phase in which, after the first warm-up phase, a mixture of the fuel and air is introduced into the anode 22, the fuel is oxidized by the oxidation catalyst, and warm-up is performed using heat generated by an oxidation reaction of the fuel.

With the above configuration, the control device for the fuel cell system (controller 16) according to the above embodiment can complete warm-up in a shorter period of time with higher energy efficiency than in the related art while maintaining the function of the reforming catalyst contained in the anode 22.

Although the embodiments of the present invention have been described above, the configurations described in the above-described embodiments are merely examples of applications of the present invention, and are not intended to limit the technical scope of the present invention.

For example, in the above-described embodiments and the like, the controller 16 estimates the anode temperature T_{AN} by calculation, but the present disclosure is not limited thereto. When the anode temperature T_{AN} can be detected by a temperature sensor or the like (not illustrated), the controller 16 can execute the first warm-up phase and the second warm-up phase using a detection value of the anode temperature T_{AN}.

1. A control method for a fuel cell system including a solid oxide fuel cell stack that uses a hydrocarbon-based fuel as a fuel and that contains, at an anode, a reforming catalyst for reforming the fuel and an oxidation catalyst for oxidizing the fuel, the control method comprising:
warming up the fuel cell system by
a first warm-up phase in which heated air is circulated at least to a cathode to warm up the fuel cell system using heat of the heated air, and
a second warm-up phase in which, after the first warm-up phase, a mixture of the fuel and air is introduced into the anode, the fuel is oxidized by the oxidation catalyst, and warm-up is performed using heat generated by an oxidation reaction of the fuel.

2. The control method for a fuel cell system according to claim 1, wherein
in the first warm-up phase, the heated air is also circulated to the anode.

3. The control method for a fuel cell system according to claim 2, wherein
the heated air circulated to the anode is the heated air discharged from the cathode.

4. The control method for a fuel cell system according to claim 2, wherein
a temperature of the anode is estimated based on temperatures of the heated air at an inlet and an outlet of the cathode and temperatures of the heated air at an inlet and an outlet of the anode, and
a timing of transition from the first warm-up phase to the second warm-up phase is determined based on the estimated temperature of the anode.

5. The control method for a fuel cell system according to claim 2, wherein
an electrical resistance between the cathode and the anode is detected,
the temperature of the anode is estimated based on the electrical resistance, and
a timing of transition from the first warm-up phase to the second warm-up phase is determined based on the estimated temperature of the anode.

6. The control method for a fuel cell system according to claim 2, wherein
in the first warm-up phase, the heated air is circulated to the anode facing the heated air circulated to the cathode,
a temperature of the heated air at an outlet of the anode is detected,
the heated air is circulated to the anode while the temperature of the heated air at the outlet of the anode is lower than a fuel oxidation temperature at which oxidation of the fuel is started by the oxidation catalyst, and
transition from the first warm-up phase to the second warm-up phase is performed when the temperature of the heated air at the outlet of the anode is equal to or higher than the fuel oxidation temperature.

7. The control method for a fuel cell system according to claim 1, wherein
in the second warm-up phase, the fuel contained in the mixture is increased until a temperature of the heated air at an outlet of the cathode is equal to or higher than a temperature of the heated air at an inlet of the cathode.

8. The control method for a fuel cell system according to claim 7, wherein
a difference in the temperatures of the heated air at the inlet and the outlet of the cathode is reduced by adjusting a flow rate of the heated air circulated to the cathode after increasing the fuel contained in the mixture.

9. The control method for a fuel cell system according to claim 7, wherein
in the second warm-up phase,
a temperature of the anode is estimated, and
an amount of the air contained in the mixture is reduced when the temperature of at least a part of the anode is equal to or higher than a reforming catalyst oxidation temperature, which is a temperature at which oxidation of the reforming catalyst is started.

10. The control method for a fuel cell system according to claim 9, wherein
a gas discharged from the anode is combusted in a combustor,
an oxygen utilization rate in the anode is estimated based on a temperature change rate of the combustor, and
the amount of the air contained in the mixture is adjusted based on the estimated oxygen utilization rate.

11. The control method for a fuel cell system according to claim 9, wherein
an oxygen concentration in a gas discharged from the anode is detected, and
the amount of the air contained in the mixture is adjusted based on the detected oxygen concentration.

12. The control method for a fuel cell system according to claim 1, wherein
a temperature of the anode is estimated at an inlet of the cathode, an outlet of the cathode, or the inlet and the outlet of the cathode, and
the second warm-up phase is continued until the estimated temperature of the anode is equal to or higher than a reduction temperature of the reforming catalyst in presence of the oxidation catalyst.

13. A control device for a fuel cell system including a solid oxide fuel cell stack that uses a hydrocarbon-based fuel as a fuel and that contains, at an anode, a reforming catalyst for reforming the fuel and an oxidation catalyst for oxidizing the fuel, wherein
the control device warms up the fuel cell system by
a first warm-up phase in which heated air is circulated at least to a cathode to warm up the fuel cell system using heat of the heated air, and
a second warm-up phase in which, after the first warm-up phase, a mixture of the fuel and air is introduced into the anode, the fuel is oxidized by the oxidation catalyst, and warm-up is performed using heat generated by an oxidation reaction of the fuel.
